(19) United States
(12) Patent Application Publication
(10) Pub. No.: US 2024/0111716 A1
(43) Pub. Date: Apr. 4, 2024

(54) DATA ANALYTICS SYSTEMS FOR FILE SYSTEMS INCLUDING EXAMPLES OF PATH GENERATION

(71) Applicant: Nutanix, Inc., San Jose, CA (US)

(72) Inventors: Sagar Gupta, Ludhiana (IN); Aditya Vasudevan, Ann Arbor, MI (US)

(21) Appl. No.: 18/183,883

(22) Filed: Mar. 14, 2023

(30) Foreign Application Priority Data
Sep. 30, 2022 (IN) 202211056298

(51) Int. Cl. G06F 16/13; G06F 16/14; G06F 16/182; G06F 16/188

(52) U.S. Cl. CPC G06F 16/13; G06F 16/148; G06F 16/183; G06F 16/188

(57) ABSTRACT

Examples of analytics systems are described which may receive metadata and event data from a file system. The metadata may include object IDs and parent object IDs for objects in the file system. Examples of analytics systems described herein may construct paths for directories in the file system based on the metadata and/or event data. Accordingly, analytics systems may store a path table including a complete path name for each directory. In this manner, path names may be returned along with analytics data to users in a user interface.

### CROSS REFERENCE TO RELATED APPLICATION(S)

This application claims priority to Indian Application No. 202211056298 filed Sep. 30, 2022, which is incorporated herein by reference, in its entirety, for any purpose.

### TECHNICAL FIELD

Examples described herein relate to data analytics systems for file systems, including distributed file servers hosting file systems. Examples of data analytics systems may generate paths for objects in the file system.

### BACKGROUND

Data, including files, are increasingly important to enterprises and individuals. The ability to store significant corpuses of files is important to the operation of many modern enterprises. Existing systems that store enterprise data may be complex or cumbersome to interact with in order to quickly or easily establish what actions have been taken with respect to the enterprise's data and what attention may be needed from an administrator. In addition, an incomplete catalog of the file system may result in an incomplete analysis of the enterprise data to determine usage characteristics and to detect anomalies.

### BRIEF DESCRIPTION OF THE DRAWINGS

FIG. 1A is a schematic illustration of a distributed computing system hosting a virtualized file server arranged in accordance with examples described herein.

FIG. 1B is a schematic illustration of the distributed computing system of FIG. 1A showing a failover of a failed file server virtual machine (FSVM) in accordance with examples described herein.

FIG. 2 is a schematic illustration of an analytics system in communication with a file server arranged in accordance with examples described herein.

FIG. 3 is a flowchart illustrating a method for generating path names for file system objects arranged in accordance with examples described herein.

FIG. 4 is an example of a share of a file system arranged in accordance with examples described herein.

FIG. 5 is an example of metadata associated with the share 402 of FIG. 4, arranged in accordance with examples described herein.

FIG. 6 is an example data path structure (e.g., data path table) which may be created using path generation techniques described herein.

FIG. 7 is an example user interface which may be provided by file analytics systems described herein.

FIG. 8 is a schematic illustration of components of a computing node (e.g., computing device or computing system) in accordance with embodiments of the present disclosure.

FIG. 9 is a schematic illustration of a method for updating paths in accordance with examples described herein when an on demand scan of a share is conducted

### DETAILED DESCRIPTION

Certain details are set forth herein to provide an understanding of described embodiments of technology. However, other examples may be practiced without various of these particular details. In some instances, well-known circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented here.

Data analytics systems described herein may provide a cloud-hosted analytics and monitoring service for file servers, which file servers may be hosted on any of a number of architectures, such as Nutanix Files and/or Isilon and/or NetApp file servers. Data analytics systems described herein may centralize data from clusters connected to admin systems operating at various data center locations. Cloud resources may reduce scaling constraints, as the cloud is not dependent on the file server resources, which may provide near-real-time analytics and alerts even for load-heavy file servers of more than 250 million files and over 500 TB of storage. Hosting file analytics on premises may limit the service to local file servers only. In contrast, systems described herein may function on a global level, in a cluster-neutral environment, without being tied to a single cluster.

Examples described herein include metadata and events-based file analytics systems for file systems. In some examples, the file systems may be implemented using hyper-converged scale out distributed file storage systems. Embodiments presented herein include a file analytics system which may retrieve, organize, aggregate, and/or analyze information pertaining to a file system. Information about the file system may be stored in an analytics datastore. The file analytics system may query or monitor the analytics datastore to provide information (e.g., to an administrator) in the form of display interfaces, reports, and alerts and/or notifications. In some examples, the file analytics system may be hosted in a remote computing environment (e.g., in a cloud computing architecture). In some examples, the file analytics system may be hosted on a computing node, whether standalone or on a cluster of computing nodes. In some examples, the file analytics system may interface with a file system managed by a distributed virtualized file server (VFS) hosted on a cluster of computing nodes. An example VFS may provide for shared storage (e.g., across an enterprise), failover and backup functionalities, as well as scalability and security of data stored on the VFS.

During operation, the file analytics system may retrieve metadata associated with the file system, configuration and/or user information from the file system, and/or event data from the file system.

In some examples, the file server may include an audit framework that manages event data in an event log. The audit framework may be configured to communicate with the analytics system to provide event data and/or metadata to the analytics system from the event log.

In some examples, the information retrieved or received by the analytics system may include event data records and metadata. The metadata collection process may include gathering the overall size, structure, and storage locations of parts of the file system managed by the file server, as well as details (e.g., file size, allocated storage quota, creation and/or modification information, owner information, permissions information, etc.) for each data item (e.g., file, folder, directory, share, etc.) in the file system. In some examples, the metadata collection process may rely on scanning one or more snapshots of the file system managed by the file server to gather the metadata, such as one or more snapshots generated by a disaster recovery application of the file server. The analytics tool may use the information gathered from the one or more snapshots to develop a comprehensive picture of the file system managed by the file server. In some examples, the analytics tool may employ multiple threads to perform scanning of the snapshots in parallel. The multiple threads may be employed to scan different shares in parallel, different files of a common share in parallel, or any combination thereof.

To capture configuration information, the file analytics system may use an application programming interface (API) architecture to request the configuration information. The configuration information may include user information, a number of shares, deleted shares, created shares, etc.

To capture event data, the VFS may include an audit framework with a connector that is configured to communicate the event data records and other information for consumption by a file analytics system. The event data records may include data related to various operations on the file system executed by the VFS, such as adding, deleting, moving, modifying, etc., a file, folder, directory, share, etc. The event data records may indicate an event type (e.g., add, move, delete, modify, a user associated with the event, an event time, etc.).

To capture event data, the file analytics system may interface with the file server to receive event data. Received event data may be stored by the file analytics system in an analytics datastore, which may be a database and/or data warehouse. The event data may include data related to various operations performed with the file system, such as creating, deleting, reading, opening, editing, moving, modifying, etc., a file, folder, directory, share, etc., within the file system. The event information may indicate an event type (e.g., create, read, edit, delete), a user associated with the event, an event time, etc. Examples of events which may be supported in some examples include file open, file write, file rename, file create, file read, file delete, security change, directory create, directory delete, file open/permission denied, file close, and/or set attribute. Events may include file server audit events (e.g., Server Message Block (SMB) audit events). Events as described herein may be for either a file, directory, share, or other item of the file server.

The file analytics system may generate reports, including predetermined reports and/or customizable reports. The reports may be related to aggregate and/or specific user activity; aggregate file system activity; specific file, directory, share, etc., activity; etc.; or any combination of thereof.

Examples described herein provide analytics which may be used, for example, to collect, analyze, and display data about a file system. Generally, data from any file system may be obtained and analyzed in accordance with techniques described herein. In some examples, the file system may be implemented as a virtualized file system, such as on a distributed virtualized file server which may host a file system. Virtualization may be advantageous in modern business and computing environments in part because of the resource utilization advantages provided by virtualized computing systems. Without virtualization, if a physical machine is limited to a single dedicated process, function, and/or operating system, then during periods of inactivity by that process, function, and/or operating system, the physical machine is not utilized to perform useful work. This may be wasteful and inefficient if there are users on other physical machines which are currently waiting for computing resources. To address this problem, virtualization allows multiple virtualized computing instances, such as virtual machines (VMs) and/or containers to share the underlying physical resources so that during periods of inactivity by one virtualized computing instance, other instances can take advantage of the resource availability to process workloads. This can produce efficiencies for the utilization of physical devices, and can result in reduced redundancies and better resource cost management.

Furthermore, virtualized computing systems may be used to not only utilize the processing power of the physical devices but also to aggregate the storage of the individual physical devices to create a logical storage pool where the data may be distributed across the physical devices but appears to the virtual machines and/or containers to be part of the system that the virtual machine and/or container is hosted on. Such systems may operate using metadata, which may be distributed and replicated any number of times across the system, to locate the indicated data.

Examples of virtualized file servers that may be used in examples described herein are also described in U.S. Published Patent Application 2017/0235760, published Aug. 17, 2017, entitled “Virtualized File Server” on U.S. application Ser. No. 15/422,220 filed Feb. 1, 2017, which application and publication are hereby incorporated herein by reference in their entirety for any purpose.

Examples of analytics systems which may be integrated with virtualized file servers are also described in U.S. application Ser. No. 17/304,096, filed Jun. 14, 2021, and entitled “File Analytics Systems and Methods,” which application is hereby incorporated by reference herein in its entirety for any purpose.

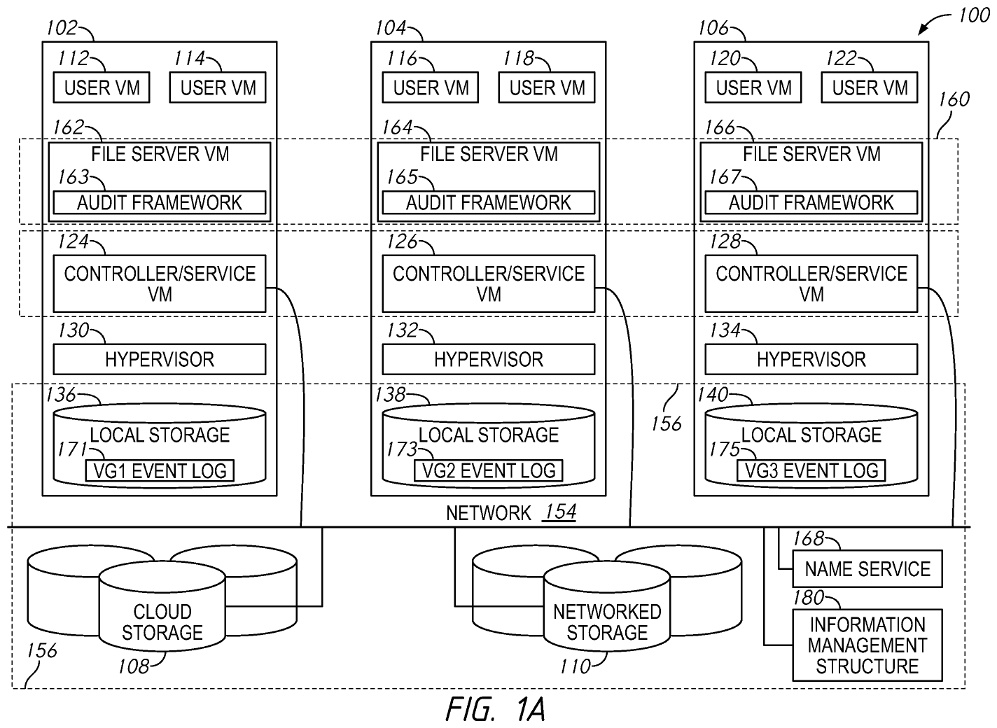

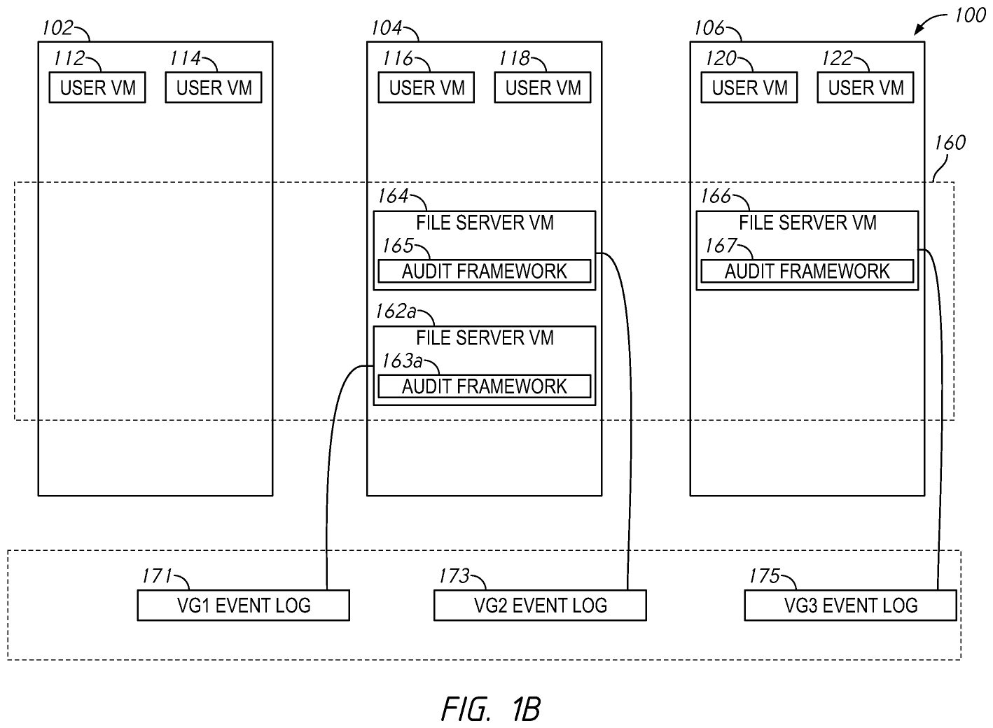

FIG. 1A is a schematic illustration of a distributed computing system hosting a virtualized file server arranged in accordance with examples described herein. The system 100, which may be a virtualized system and/or a clustered virtualized system, includes a virtualized file server (VFS) 160. While shown as a virtual machine, examples of analytics applications may be implemented using one or more virtual computing instances, which may be implemented for example as virtual machines, containers, or combinations thereof. In some examples an analytics system, which may include an analytics datastore, may be provided as a hosted solution in one or more cloud computing platforms, which may be in communication with the system 100 of FIG. 1A.

The system of FIG. 1A can be implemented using a distributed computing system. Distributed computing systems generally include multiple computing nodes (e.g., physical computing resources)—host machines 102, 106, and 104 are shown in FIG. 1A—that may manage shared storage, which may be arranged in multiple tiers. The storage may include storage that is accessible through network 154, such as, by way of example and not limitation, cloud storage 108 (e.g., which may be accessible through the Internet), network-attached storage 110 (NAS) (e.g., which may be accessible through a LAN), or a storage area network (SAN). Examples described herein may also or instead permit local storage 136, 138, and 140 that is incorporated into or directly attached to the host machine and/or appliance to be managed as part of storage pool 156. Accordingly, the storage pool may include local storage of one or more of the computing nodes in the system, storage accessible through a network, or both local storage of one or more of the computing nodes in the system and storage accessible over a network. In some examples, the storage pool 156 may include only the local storage of nodes in the cluster—e.g., local storage 136, 138, and 140. Examples of local storage may include solid state drives (SSDs), hard disk drives (HDDs, and/or “spindle drives”), optical disk drives, external drives (e.g., a storage device connected to a host machine via a native drive interface, or a serial attached SCSI interface), or any other direct-attached storage. These storage devices, both direct-attached and/or network-accessible, collectively form storage pool 156 in some examples. Virtual disks (or “vDisks”) may be structured from the physical storage devices in storage pool 156. A vDisk generally refers to a storage abstraction that is exposed by a component (e.g., a virtual machine, hypervisor, and/or container described herein) to be used by a client (e.g., a user VM, such as user VM 112). In examples described herein, controller VMs—e.g., controller VM 124, 126, and/or 128 of FIG. 1A may provide access to vDisks. In other examples, access to vDisks may additionally or instead be provided by one or more hypervisors (e.g., hypervisor 130, 132, and/or 134). In some examples, the vDisk may be exposed via iSCSI (“internet small computer system interface”) or NFS (“network file system”) and may be mounted as a virtual disk on the user VM. In some examples, vDisks may be organized into one or more volume groups (VGs).

Each host machine 102, 106, 104 may run virtualization software. Virtualization software may include one or more virtualization managers (e.g., one or more virtual machine managers, such as one or more hypervisors, and/or one or more container managers). Examples of hypervisors include NUTANIX AHV, VMWARE ESX(I), MICROSOFT HYPER-V, DOCKER hypervisor, and REDHAT KVM. Examples of container managers include Kubernetes. The virtualization software shown in FIG. 1A includes hypervisors 130, 132, and 134 which may create, manage, and/or destroy user VMs, as well as manage the interactions between the underlying hardware and user VMs. While hypervisors are shown in FIG. 1A, containers may be used additionally or instead in other examples. User VMs may run one or more applications that may operate as “clients” with respect to other elements within system 100. While shown as virtual machines in FIG. 1A, containers may be used to implement client processes in other examples. Hypervisors may connect to one or more networks, such as network 154 of FIG. 1A, to communicate with storage pool 156 and/or other computing system(s) or components.

In some examples, controller virtual machines, such as CVMs 124, 126, and 128 of FIG. 1A, are used to manage storage and input/output (“I/O”) activities according to particular embodiments. While examples are described herein using CVMs to manage storage I/O activities, in other examples, container managers and/or hypervisors may additionally or instead be used to perform described CVM functionality. The arrangement of virtualization software should be understood to be flexible. In some examples, CVMs act as the storage controller. Multiple such storage controllers may coordinate within a cluster to form a unified storage controller system. CVMs may run as virtual machines on the various host machines, and work together to form a distributed system that manages all the storage resources, including local storage, network-attached storage 110, and cloud storage 108. The CVMs may connect to network 154 directly, or via a hypervisor. Since the CVMs run independent of hypervisors 130, 132, 134, in examples where CVMs provide storage controller functionally, the system may be implemented within any virtual machine architecture since the CVMs of particular embodiments can be used in conjunction with any hypervisor from any virtualization vendor. In other examples, the hypervisor may provide storage controller functionality and/or one or more containers may be used to provide storage controller functionality (e.g., to manage I/O requests to and from the storage pool 156).

A host machine may be designated as a leader node within a cluster of host machines. For example, host machine 104 may be a leader node. A leader node may have a software component designated to perform operations of the leader. For example, CVM 126 on host machine 104 and/or file server VM 164 of host machine 104 may be designated to perform such operations. A leader may be responsible for monitoring or handling requests from other host machines or software components on other host machines throughout the virtualized environment. For example, a leader service may handle the distribution of requests to and from other instances of that service throughout the distributed environment. If a leader fails, a new leader may be designated. In particular embodiments, a management module (e.g., in the form of an agent) may be running on the leader node.

Virtual disks may be made available to one or more user processes. In the example of FIG. 1A, each CVM 124, 126, and 128 may export one or more block devices or NFS server targets that appear as disks to user VMs 112, 114, 116, 118, 120, and 122. These disks are virtual, since they are implemented by the software running inside CVMs 124, 126, and 128. Thus, to user VMs, CVMs appear to be exporting a clustered storage appliance that contains some disks. User data (e.g., including the operating system in some examples) in the user VMs may reside on these virtual disks.

Performance advantages can be gained in some examples by allowing the virtualization system to access and utilize local storage 136, 138, and 140. This is because I/O performance may be much faster when performing access to local storage as compared to performing access to network-attached storage 110 across a network 154. This faster performance for locally attached storage can be increased even further by using certain types of optimized local storage devices, such as SSDs.

As a user process (e.g., a user VM) performs I/O operations (e.g., a read operation or a write operation), the I/O commands may be sent to the hypervisor that shares the same server as the user process, in examples utilizing hypervisors. For example, the hypervisor may present to the virtual machines an emulated storage controller, receive an I/O command, and facilitate the performance of the I/O command (e.g., via interfacing with storage that is the object of the command, or passing the command to a service that will perform the I/O command). An emulated storage controller may facilitate I/O operations between a user VM and a vDisk. A vDisk may present to a user VM as one or more discrete storage drives, but each vDisk may correspond to any part of one or more drives within storage pool 156. Additionally or alternatively, CVMs 124, 126, 128 may present an emulated storage controller either to the hypervisor or to user VMs to facilitate I/O operations. CVMs 124, 126, and 128 may be connected to storage within storage pool 156. CVM 124 may have the ability to perform I/O operations using local storage 136 within the same host machine 102, by connecting via network 154 to cloud storage 108 or network-attached storage 110, or by connecting via network 154 to local storage 138 or 140 within another host machine 104 or 106 (e.g., via connecting to another CVM 126 or 128). In particular embodiments, any computing system may be used to implement a host machine.

Examples described herein include virtualized file servers. A virtualized file server may be implemented using a cluster of virtualized software instances (e.g., a cluster of file server virtual machines). A virtualized file server 160 is shown in FIG. 1A including a cluster of file server virtual machines. The file server virtual machines may additionally or instead be implemented using containers. In some examples, the VFS 160 provides file services to user VMs 112, 114, 116, 118, 120, and 122. The file services may include storing and retrieving data persistently, reliably, and/or efficiently in some examples. The user virtual machines may execute user processes, such as office applications or the like, on host machines 102, 104, and 106. The stored data may be represented as a set of storage items, such as files organized in a hierarchical structure of folders (also known as directories), which can contain files and other folders, and shares, which can also contain files and folders. Generally, the file server virtual machines may present a single namespace of storage items to user VMs.

In particular embodiments, the VFS 160 may include a set of file server virtual machines (FSVMs) 162, 164, and 166 that execute on host machines 102, 104, and 106. The set of file server virtual machines (FSVMs) may operate together to form a cluster. The FSVMs may process storage item access operations requested by user VMs executing on the host machines 102, 104, and 106. The FSVMs 162, 164, and 166 may communicate with storage controllers provided by CVMs 124, 126, 128 and/or hypervisors executing on the host machines 102, 104, 106 to store and retrieve files, folders, SMB shares, or other storage items. The FSVMs 162, 164, and 166 may store and retrieve block-level data on the host machines 102, 104, 106, e.g., on the local storage 136, 138, 140 of the host machines 102, 104, 106. The block-level data may include block-level representations of the storage items. The network protocol used for communication between user VMs, FSVMs, CVMs, and/or hypervisors via the network 154 may be Internet Small Computer Systems Interface (iSCSI), Server Message Block (SMB), Network File System (NFS), pNFS (Parallel NFS), or another appropriate protocol.

Generally, FSVMs may be utilized to receive and process requests in accordance with a file system protocol—e.g., NFS, SMB. In this manner, the cluster of FSVMs may provide a file system that may present files, folders, and/or a directory structure to users, where the files, folders, and/or directory structure may be distributed across a storage pool in one or more shares. The cluster of FSVMs may present a single namespace of storage items of a file system stored in the storage pool.

For the purposes of VFS 160, host machine 106 may be designated as a leader node within a cluster of host machines. In this case, FSVM 166 on host machine 106 may be designated to perform such operations. A leader may be responsible for monitoring or handling requests from FSVMs on other host machines throughout the virtualized environment. If FSVM 166 fails, a new leader may be designated for VFS 160.

In some examples, the user VMs may send data to the VFS 160 using write requests, and may receive data from it using read requests. The read and write requests, and their associated parameters, data, and results, may be sent between a user VM and one or more file server VMs (FSVMs) located on the same host machine as the user VM or on different host machines from the user VM. The read and write requests may be sent between host machines 102, 104, 106 via network 154, e.g., using a network communication protocol such as iSCSI, CIFS, SMB, TCP, Internet Protocol (IP), or the like. When a read or write request is sent between two VMs located on the same one of the host machines 102, 104, 106 (e.g., between the user VM 112 and the FSVM 162 located on the host machine 102), the request may be sent using local communication within the host machine 102 instead of via the network 154. Such local communication may be faster than communication via the network 154 in some examples. The local communication may be performed by, e.g., writing to and reading from shared memory accessible by the user VM 112 and the FSVM 162, sending and receiving data via a local “loopback” network interface, local stream communication, or the like.

In some examples, the storage items stored by the VFS 160, such as files and folders, may be distributed among storage managed by multiple FSVMs 162, 164, 166. In some examples, when storage access requests are received from the user VMs, the VFS 160 identifies FSVMs 162, 164, 166 at which requested storage items, e.g., folders, files, or portions thereof, are stored or managed, and directs the user VMs to the locations of the storage items. The FSVMs 162, 164, 166 may maintain a storage map, such as a sharding map, that maps names or identifiers of storage items to their corresponding locations. The storage map may be a distributed data structure of which copies are maintained at each FSVM 162, 164, 166 and accessed using distributed locks or other storage item access operations. In some examples, the storage map may be maintained by an FSVM at a leader node such as the FSVM 166, and the other FSVMs 162 and 164 may send requests to query and update the storage map to the leader FSVM 166. Other implementations of the storage map are possible using appropriate techniques to provide asynchronous data access to a shared resource by multiple readers and writers. The storage map may map names or identifiers of storage items in the form of text strings or numeric identifiers, such as file system paths, folder names, file names, and/or identifiers of portions of folders or files (e.g., numeric start offset positions and counts in bytes or other units) to locations of the files, folders, or portions thereof. Locations may be represented as names of FSVMs, e.g., “FSVM-1”, as network addresses of host machines on which FSVMs are located (e.g., “ip-addr1” or 128.1.1.10), or as other types of location identifiers.

When a user application, e.g., executing in a user VM 112 on host machine 102 initiates a storage access operation, such as reading or writing data, the user VM 112 may send the storage access operation in a request to one of the FSVMs 162, 164, 166 on one of the host machines 102, 104, 106. An FSVM 164 executing on a host machine 102 that receives a storage access request may use the storage map to determine whether the requested file or folder is located on and/or managed by the FSVM 164. If the requested file or folder is located on and/or managed by the FSVM 164, the FSVM 164 executes the requested storage access operation. Otherwise, the FSVM 164 responds to the request with an indication that the data is not on the FSVM 164, and may redirect the requesting user VM 112 to the FSVM on which the storage map indicates the file or folder is located. The client may cache the address of the FSVM on which the file or folder is located, so that it may send subsequent requests for the file or folder directly to that FSVM.

As an example and not by way of limitation, the location of a file or a folder may be pinned to a particular FSVM 162 by sending a file service operation that creates the file or folder to a CVM, container, and/or hypervisor associated with (e.g., located on the same host machine as) the FSVM 162—the CVM 124 in the example of FIG. 1A. The CVM, container, and/or hypervisor may subsequently process file service commands for that file for the FSVM 162 and send corresponding storage access operations to storage devices associated with the file. In some examples, the FSVM may perform these functions itself. The CVM 124 may associate local storage 136 with the file if there is sufficient free space on local storage 136. Alternatively, the CVM 124 may associate a storage device located on another host machine 104, e.g., in local storage 138, with the file under certain conditions, e.g., if there is insufficient free space on the local storage 136, or if storage access operations between the CVM 124 and the file are expected to be infrequent. Files and folders, or portions thereof, may also be stored on other storage devices, such as the network-attached storage (NAS) 110 or the cloud storage 108 of the storage pool 156.

In particular embodiments, a name service 168, such as that specified by the Domain Name System (DNS) Internet protocol, may communicate with the host machines 102, 104, 106 via the network 154 and may store a database of domain names (e.g., host names) to IP address mappings. The domain names may correspond to FSVMs, e.g., fsvm1.domain.com or ip-addr1.domain.com for an FSVM named FSVM-1. The name service 168 may be queried by the user VMs to determine the IP address of a particular host machine (e.g., computing node) 102, 104, 106 given a name of the host machine, e.g., to determine the IP address of the host name ip-addr1 for the host machine 102. The name service 168 may be located on a separate server computer system or on one or more of the host machines 102, 104, 106. The names and IP addresses of the host machines of the VFS 160, e.g., the host machines 102, 104, 106, may be stored in the name service 168 so that the user VMs may determine the IP address of each of the host machines 102, 104, 106, or FSVMs 162, 164, 166. The name of each VFS instance, e.g., FS1, FS2, or the like, may be stored in the name service 168 in association with a set of one or more names that contains the name(s) of the host machines 102, 104, 106 or FSVMs 162, 164, 166 of the VFS 160 instance. The FSVMs 162, 164, 166 may be associated with the host names ip-addr1, ip-addr2, and ip-addr3, respectively. For example, the file server instance name FS1.domain.com may be associated with the host names ip-addr1, ip-addr2, and ip-addr3 in the name service 168, so that a query of the name service 168 for the server instance name “FS1” or “FS1.domain.com” returns the names ip-addr1, ip-addr2, and ip-addr3. As another example, the file server instance name FS1.domain.com may be associated with the host names fsvm-1, fsvm-2, and fsvm-3. Further, the name service 168 may return the names in a different order for each name lookup request, e.g., using round-robin ordering, so that the sequence of names (or addresses) returned by the name service for a file server instance name is a different permutation for each query until all the permutations have been returned in response to requests, at which point the permutation cycle starts again, e.g., with the first permutation. In this way, storage access requests from user VMs may be balanced across the host machines, since the user VMs submit requests to the name service 168 for the address of the VFS instance for storage items for which the user VMs do not have a record or cache entry, as described below.

In particular embodiments, each FSVM may have two IP (Internet Protocol) addresses: an external IP address and an internal IP address. The external IP addresses may be used by SMB/CIFS clients, such as user VMs, to connect to the FSVMs. The external IP addresses may be stored in the name service 168. The IP addresses ip-addr1, ip-addr2, and ip-addr3 described above are examples of external IP addresses. The internal IP addresses may be used for iSCSI communication to CVMs, e.g., between the FSVMs 162, 164, 166 and the CVMs 124, 126, 128. Other internal communications may be sent via the internal IP addresses as well, e.g., file server configuration information may be sent from the CVMs to the FSVMs using the internal IP addresses, and the CVMs may get file server statistics from the FSVMs via internal communication.

Since the VFS 160 is provided by a distributed cluster of FSVMs 162, 164, 166, the user VMs that access particular requested storage items, such as files or folders, do not necessarily know the locations of the requested storage items when the request is received. A distributed file system protocol, e.g., MICROSOFT DFS or the like, may therefore be used, in which a user VM 112 may request the addresses of FSVMs 162, 164, 166 from a name service 168 (e.g., DNS). The name service 168 may send one or more network addresses of FSVMs 162, 164, 166 to the user VM 112. The addresses may be sent in an order that changes for each subsequent request in some examples. These network addresses are not necessarily the addresses of the FSVM 164 on which the storage item requested by the user VM 112 is located, since the name service 168 does not necessarily have information about the mapping between storage items and FSVMs 162, 164, 166. Next, the user VM 112 may send an access request to one of the network addresses provided by the name service, e.g., the address of FSVM 164. The FSVM 164 may receive the access request and determine whether the storage item identified by the request is located on the FSVM 164. If so, the FSVM 164 may process the request and send the results to the requesting user VM 112. However, if the identified storage item is located on a different FSVM 166, then the FSVM 164 may redirect the user VM 112 to the FSVM 166 on which the requested storage item is located by sending a “redirect” response referencing FSVM 166 to the user VM 112. The user VM 112 may then send the access request to FSVM 166, which may perform the requested operation for the identified storage item.

A particular VFS 160, including the items it stores, e.g., files and folders, may be referred to herein as a VFS “instance” and may have an associated name, e.g., FS1, as described above. Although a VFS instance may have multiple FSVMs distributed across different host machines, with different files being stored on FSVMs, the VFS instance may present a single name space to its clients such as the user VMs. The single name space may include, for example, a set of named “shares” and each share may have an associated folder hierarchy in which files are stored. Storage items such as files and folders may have associated names and metadata such as permissions, access control information, size quota limits, file types, files sizes, and so on. As another example, the name space may be a single folder hierarchy, e.g., a single root directory that contains files and other folders. User VMs may access the data stored on a distributed VFS instance via storage access operations, such as operations to list folders and files in a specified folder, create a new file or folder, open an existing file for reading or writing, and read data from or write data to a file, as well as storage item manipulation operations to rename, delete, copy, or get details, such as metadata, of files or folders. Note that folders may also be referred to herein as “directories.”

In particular embodiments, storage items such as files and folders in a file server namespace may be accessed by clients, such as user VMs, by name and/or path, e.g., “\Folder-1\File-1” and “\Folder-2\File-2” for two different files named File-1 and File-2 in the folders Folder-1 and Folder-2, respectively (where Folder-1 and Folder-2 are sub-folders of the root folder). Names that identify files in the namespace using folder names and file names may be referred to as “path names.” Client systems may access the storage items stored on the VFS instance by specifying the file names or path names, e.g., the path name “\Folder-1 \File-1”, in storage access operations. If the storage items are stored on a share (e.g., a shared drive), then the share name may be used to access the storage items, e.g., via the path name “\\Share-1\Folder-1 \File-1” to access File-1 in folder Folder-1 on a share named Share-1.

In particular embodiments, although the VFS may store different folders, files, or portions thereof at different locations, e.g., on different FSVMs, the use of different FSVMs or other elements of storage pool 156 to store the folders and files may be hidden from the accessing clients. The share name is not necessarily a name of a location such as an FSVM or host machine. For example, the name Share-1 does not identify a particular FSVM on which storage items of the share are located. The share Share-1 may have portions of storage items stored on three host machines, but a user may simply access Share-1, e.g., by mapping Share-1 to a client computer, to gain access to the storage items on Share-1 as if they were located on the client computer. Names of storage items, such as file names and folder names, may similarly be location-independent. Thus, although storage items, such as files and their containing folders and shares, may be stored at different locations, such as different host machines, the files may be accessed in a location-transparent manner by clients (such as the user VMs). Thus, users at client systems need not specify or know the locations of each storage item being accessed. The VFS may automatically map the file names, folder names, or full path names to the locations at which the storage items are stored. As an example and not by way of limitation, a storage item's location may be specified by the name, address, or identity of the FSVM that provides access to the storage item on the host machine on which the storage item is located. A storage item such as a file may be divided into multiple parts that may be located on different FSVMs, in which case access requests for a particular portion of the file may be automatically mapped to the location of the portion of the file based on the portion of the file being accessed (e.g., the offset from the beginning of the file and the number of bytes being accessed).

In particular embodiments, VFS 160 determines the location, e.g., FSVM, at which to store a storage item when the storage item is created. For example, an FSVM 162 may attempt to create a file or folder using a CVM 124 on the same host machine 102 as the user VM 114 that requested creation of the file, so that the CVM 124 that controls access operations to the file folder is co-located with the user VM 114. While operations with a CVM are described herein, the operations could also or instead occur using a hypervisor and/or container in some examples. In this way, since the user VM 114 is known to be associated with the file or folder and is thus likely to access the file again, e.g., in the near future or on behalf of the same user, access operations may use local communication or short-distance communication to improve performance, e.g., by reducing access times or increasing access throughput. If there is a local CVM on the same host machine as the FSVM, the FSVM may identify it and use it by default. If there is no local CVM on the same host machine as the FSVM, a delay may be incurred for communication between the FSVM and a CVM on a different host machine. Further, the VFS 160 may also attempt to store the file on a storage device that is local to the CVM being used to create the file, such as local storage, so that storage access operations between the CVM and local storage may use local or short-distance communication.

In some examples, if a CVM is unable to store the storage item in local storage of a host machine on which an FSVM resides, e.g., because local storage does not have sufficient available free space, then the file may be stored in local storage of a different host machine. In this case, the stored file is not physically local to the host machine, but storage access operations for the file are performed by the locally-associated CVM and FSVM, and the CVM may communicate with local storage on the remote host machine using a network file sharing protocol, e.g., iSCSI, SAMBA, or the like.

In some examples, if a virtual machine, such as a user VM 112, CVM 124, or FSVM 162, moves from a host machine 102 to a destination host machine 104, e.g., because of resource availability changes, and data items such as files or folders associated with the VM are not locally accessible on the destination host machine 104, then data migration may be performed for the data items associated with the moved VM to migrate them to the new host machine 104, so that they are local to the moved VM on the new host machine 104. FSVMs may detect removal and addition of CVMs (as may occur, for example, when a CVM fails or is shut down) via the iSCSI protocol or other technique, such as heartbeat messages. As another example, an FSVM may determine that a particular file's location is to be changed, e.g., because a disk on which the file is stored is becoming full, because changing the file's location is likely to reduce network communication delays and therefore improve performance, or for other reasons. Upon determining that a file is to be moved, VFS 160 may change the location of the file by, for example, copying the file from its existing location(s), such as local storage 136 of a host machine 102, to its new location(s), such as local storage 138 of host machine 104 (and to or from other host machines, such as local storage 140 of host machine 106 if appropriate), and deleting the file from its existing location(s). Write operations on the file may be blocked or queued while the file is being copied, so that the copy is consistent. The VFS 160 may also redirect storage access requests for the file from an FSVM at the file's existing location to an FSVM at the file's new location.

In particular embodiments, VFS 160 includes at least three file server virtual machines (FSVMs) 162, 164, 166 located on three respective host machines 102, 104, 106. To provide high-availability, in some examples, there may be a maximum of one FSVM for a particular VFS instance VFS 160 per host machine in a cluster. If two FSVMs are detected on a single host machine, then one of the FSVMs may be moved to another host machine automatically in some examples, or the user (e.g., system administrator) may be notified to move the FSVM to another host machine. The user may move an FSVM to another host machine using an administrative interface that provides commands for starting, stopping, and moving FSVMs between host machines.

In some examples, two FSVMs of different VFS instances may reside on the same host machine. If the host machine fails, the FSVMs on the host machine become unavailable, at least until the host machine recovers. Thus, if there is at most one FSVM for each VFS instance on each host machine, then at most one of the FSVMs may be lost per VFS per failed host machine. As an example, if more than one FSVM for a particular VFS instance were to reside on a host machine, and the VFS instance includes three host machines and three FSVMs, then loss of one host machine would result in loss of two-thirds of the FSVMs for the VFS instance, which may be more disruptive and more difficult to recover from than loss of one-third of the FSVMs for the VFS instance.

In some examples, users, such as system administrators or other users of the system and/or user VMs, may expand the cluster of FSVMs by adding additional FSVMs. Each FSVM may be associated with at least one network address, such as an IP (Internet Protocol) address of the host machine on which the FSVM resides. There may be multiple clusters, and all FSVMs of a particular VFS instance are ordinarily in the same cluster. The VFS instance may be a member of a MICROSOFT ACTIVE DIRECTORY domain, which may provide authentication and other services such as a name service.

In some examples, files hosted by a virtualized file server, such as the VFS 160, may be provided in shares—e.g., SMB shares and/or NFS exports. SMB shares may be distributed shares (e.g., home shares) and/or standard shares (e.g., general shares). NFS exports may be distributed exports (e.g., sharded exports) and/or standard exports (e.g., non-sharded exports). A standard share may in some examples be an SMB share and/or an NFS export hosted by a single FSVM (e.g., FSVM 162, FSVM 164, and/or FSVM 166 of FIG. 1A). The standard share may be stored, e.g., in the storage pool in one or more volume groups and/or vDisks and may be hosted (e.g., accessed and/or managed) by the single FSVM. The standard share may correspond to a particular folder (e.g., \\enterprise\finance may be hosted on one FSVM, \\enterprise\hr on another FSVM). In some examples, distributed shares may be used which may distribute hosting of a top-level directory (e.g., a folder) across multiple FSVMs. So, for example, \\enterprise\users\ann and \\enterprise\users\bob may be hosted at a first FSVM, while \\enterprise\users\chris and \\enterprise\users\dan are hosted at a second FSVM. In this manner a top-level directory (e.g., \\enterprise\users) may be hosted across multiple FSVMs. This may also be referred to as a sharded or distributed share (e.g., a sharded SMB share). As discussed, a distributed file system protocol, e.g., MICROSOFT DFS or the like, may be used, in which a user VM may request the addresses of FSVMs 162, 164, 166 from a name service (e.g., DNS).

Accordingly, systems described herein may include one or more virtual file servers, where each virtual file server may include a cluster of file server VMs and/or containers operating together to provide a file system. Examples of systems described herein may include a file analytics system that may collect, monitor, store, analyze, and report on various analytics associated with the virtual file server(s). By providing a file analytics system, system administrators may advantageously find it easier to manage their files stored in a file system, and may more easily gain, understand, protect, and utilize insights about the stored data and/or the usage of the file system over time. Examples of file analytics systems are described as being provided in a hosted system (e.g., cloud computing system), however, it is to be understood that the analytics VM may be implemented in various examples using one or more virtual machines and/or one or more containers or other virtual computing instances.

Accordingly, an analytics system may be in communication with the system 100 of FIG. 1A. The analytics system may retrieve, organize, aggregate, and/or analyze information corresponding to a file system. The information may be stored in an analytics datastore. The analytics system may query or monitor the analytics datastore to provide information to an administrator in the form of display interfaces, reports, and alerts/notifications. The analytics system may be provided as a hosted analytics system on a computing system and/or platform in communication with the VFS 160. For example, the analytics system may be provided as a hosted analytics system in the cloud—e.g., provided on one or more cloud computing platforms.

During operation, the analytics system may perform multiple functions related to information collection, including a metadata collection process to receive metadata associated with the file system, a configuration information collection process to receive configuration and user information from the VFS 160, and an event data collection process to receive event data from the VFS 160.

The metadata collection process may include gathering the overall size, structure, and storage locations of the VFS 160 and/or parts of the file system managed by the VFS 160, as well as details for one or more (e.g., each) data item (e.g., file, folder, directory, share, etc.) in the VFS 160 and/or other metadata associated with the VFS 160. In some examples, the analytics system may communicate with each of the FSVMs 162, 164, 166 of the VFS 160 during the metadata collection process to retrieve respective portions of the metadata.

In some examples, the analytics system may make an initial scan of the VFS 160 to obtain initial metadata concerning the file system (e.g., number of files, directories, file names, file sizes, file owner ID and/or name, file permissions (e.g., access control lists, etc.)). The analytics system may provide an API call (e.g., SMB ACL call) to the VFS 160 to retrieve owner usernames and/or ACL permission information based on the owner identifier and the ACL identifier.

In some examples, the analytics system may communicate with each of the FSVMs 162, 164, 166 of the VFS 160 during the metadata collection process to retrieve respective portions of the metadata from the file system. In some examples, the metadata collection processes performed by the analytics system may include a multi-threaded breadth-first search (BFS) that involves performing parallel threaded file system scanning. The parallel threaded file system scanning may include parallel scanning of different shares, parallel scanning of different folders of a common share, or any combination thereof. In some examples, the metadata collection process may implement a parallel BFS with level order traversal of a directory tree to collect metadata. Level order traversal may include processing a directory tree one level at a time. For example, starting with a top-level directory, a first level of a directory tree is processed before moving onto a next level of the directory tree. The level order traversal includes a current queue, which includes each item in the level of the directory tree currently being processed, and a next queue, which includes children of the level of the directory tree currently being processed. When processing of the current queue is completed, the current queue may be loaded with the next queue entries. By performing level order traversal, a size of the two queues may be more manageable, as compared with a system where every item from a directory tree is loaded into a single queue. The parallel BFS may include starting a thread on each level, and letting processing of all the data items on that level be completed in the current queue before making a move to the next or child queue.

To capture configuration information, the analytics system may use an application programming interface (API) architecture to request the configuration information from the VFS 160. The API architecture may include representation state transfer (REST) API architecture. The configuration information may include user information, a number of shares, deleted shares, created shares, etc. In some examples, the analytics system may communicate directly with the leader FSVM of the FSVMs 162, 164, 166 of the VFS 160 to collect the configuration information. In some examples, the analytics system may communicate directly with another component (e.g., application, process, and/or service) of the VFS 160 or of the distributed computing system 100 (e.g., one or more storage controllers, virtualization managers, the CVMs 124, 126, 128, the hypervisors 130, 132, 134, etc.) to collect the configuration information. In some examples, the analytics system may communicate directly with another component (e.g., application, process, and/or service) of the VFS 160 or of the distributed computing system or in communication with the distributed computing system 100 (e.g., computing node, an administrative system, a storage controller, the CVMs 124, 126, 128, the hypervisors 130, 132, 134, etc.) to collect the configuration information.

To capture event data, the analytics system may interface with the VFS 160 to receive event data for storage in an analytics datastore. The VFS 160 may include or may be associated with an audit framework with a connector that is configured to provide the event data for consumption by the analytics system. For example, the FSVMs 162, 164, 166 of the VFS 160 may each include or may be associated with a respective audit framework 163, 165, 167 with a connector that may provide the event data to the analytics system. In some examples, while the audit framework 163, 165, 167 for each FSVM 162, 164, 166 is depicted as being part of the FSVMs 162, 164, 166, the audit framework 163, 165, 167 may be hosted by another component (e.g., application, process, and/or service) of the VFS 160 or of the distributed computing system 100 (e.g., one or more storage controller(s), the CVMs 124, 126, 128, the hypervisors 130, 132, 134, etc.) without departing from the scope of the disclosure. The audit framework generally refers to one or more software components which may be provided to collect, store, analyze, and/or transmit audit data (e.g., data regarding events in the file system). The event data may include data related to various operations performed with the VFS 160, such as adding, deleting, moving, modifying, etc., a file, folder, directory, share, etc., within the VFS 160. The event information may indicate an event type (e.g., add, move, delete, modify), a user associated with the event, an event time, etc. In some examples, once an event is written to the analytics datastore, it is not able to be modified. In some examples, the analytics system may aggregate multiple events into a single event for storage in the analytics datastore. For example, if a known task (e.g., moving a file) results in generation of a predictable sequence of events, the analytics system may aggregate that sequence into a single event.

In some examples, the analytics system and/or the corresponding VFS 160 may include protections to prevent event data from being lost. In some examples, the VFS 160 may store event data until it is provided to the analytics system. For example, if the analytics system becomes unavailable, the VFS 160 may persistently store the event data until the analytics system becomes available.

To support the persistent storage, as well as provision of the event data to the analytics system, the FSVMs 162, 164, 166 of the VFS 160 may each include or be associated with the audit framework that includes a dedicated event log (e.g., tied to an FSVM-specific volume group) that is capable of being scaled to store all event data and/or metadata for a particular FSVM until successfully sent to the analytics system. In some examples, the audit framework for each FSVM 162, 164, 166 may be hosted by another component (e.g., application, process, and/or service) of the VFS 160 or of the distributed computing system or in communication with the distributed computing system 100 (e.g., computing node, an administrative system, a storage controller, the CVMs 124, 126, 128, the hypervisors 130, 132, 134, etc.)

For example, each respective audit framework 163, 165, 167 may manage a separate respective event log via a separate volume group (e.g., the audit framework 163 manages the volume group 1 (VG1) event log 171, the audit framework 165 manages the volume group 2 (VG2) event log 173, and the audit framework 167 manages the volume group 3 (VG3) event log 175). The VG1-3 event logs 171, 173, and 175 may each be capable of being scaled to store all event data and/or metadata for parts of the VFS 160 that are managed by the respective FSVM 162, 164, 166. In some examples, the data may be persisted (e.g., maintained) until successfully provided to the analytics system. While the VG1-3 event logs 171, 173, 175 are each shown in the respective local storages 136, 138, and 140, the VG1-3 event logs 171, 173, 175 may be maintained anywhere in the storage pool 156 without departing from the scope of the disclosure.

In some examples, if one of the FSVMs 162, 164, or 166 fails, the failed FSVM may be migrated to another one of the host machines (e.g., computing nodes) 102, 104, or 106. In addition, the audit framework 163, 165, or 167 associated with the failed FSVM may also migrate over to the same computing node as the failed FSVM, and may continue updating the same VG1-3 event log 171, 173, or 175 based on the write index. FIG. 1B is a schematic illustration of the distributed computing system 100 of FIG. 1A showing a failover of a failed FSVM in accordance with examples described herein. As shown in FIG. 1B, the FSVM 162 has failed. In response to failure of the FSVM 162, the FSVM 162 may be migrated to the computing node 104 as FSVM 162a. In addition, the audit framework 163 may be migrated to the computing node 104 as the audit framework 163a. The FSVM 162 may mount the VG1 event log 171 to continue updating the event log based on a write index established by the audit framework 163. In some examples, rather than migrating as a separate VM, the file server VM 162's role may be assumed by the file server VM 164 and/or another file server VM. For example, responsive to failure of the FSVM 162, the FSVM 164 or an audit framework associated with the FSVM 164 may manage the VG1 event log 171. The VG1 event log 171 may be migrated to a volume group of the FSVM 164 and/or may otherwise be made accessible to the FSVM 164 and/or an audit framework associated with the FSVM 164.

The audit framework (e.g., each audit framework 163, 165, and/or 167) may include an audit queue, an event logger, an event log, and a service connector. The audit queue may be configured to receive event data and/or metadata from the VFS 160 via network file server or server message block server communications, and to provide the event data and/or metadata to the mediator (e.g., event logger). The event logger may be configured to store the received event data and/or metadata from the audit queue, as well as retrieve requested event data and/or metadata from the event log in response to a request from the service connector. The service connector may be configured to communicate with other services (e.g., such as the analytics VM system) to respond to requests for provision of event data and/or metadata, as well as receive acknowledgments when event data and/or metadata are successfully received by the analytics system. The events in the event log may be uniquely identified by a monotonically increasing sequence number, will be persisted to an event log, and will be read from it when requested by the service connector.

The event logger may coordinate all of the event data and/or metadata writes and reads to and from the event log, which may facilitate the use of the event log for multiple services. The event logger may keep the in-memory state of the write index in the event log, and may persist it periodically to a control record (e.g., a master block). When the audit framework is started or restarted, the master record may be read to set the write index.

Multiple services may be able to read from an event log (e.g., the VG1-3 event logs 171, 173, 175) via their own service connectors (e.g., Kafka connectors). A service connector may have the responsibility of sending event data and metadata to the requesting service (e.g., such as the analytics system) reliably, keeping track of its state, and reacting to its failure and recovery. Each service connector may be tasked with persisting its respective read index, as well as being able to communicate the respective read index to the event logger when initiating an event read. The service connector may increment the in-memory read index only after receiving acknowledgment from its corresponding service and will periodically persist in-memory state. The persisted read index value may be read at start/restart (e.g., or after a service interruption) and used to set the in-memory read index to a value from which to start reading from. In some examples, when an event data record is read from the event log by a particular service, the event logger may stop maintenance of the event data record (e.g., allow it to be overwritten or removed from the event log).

During service start/recovery, a service connector may detect its presence and initiate an event read by communicating the read index to the event logger to read from the event log as part of the read call. The event logger may use the read index to find the next event to read and send to the requesting service (e.g., the analytics system) via the service connector.

The analytics system and/or the VFS 160 may further include architecture to prevent event data from being processed out of chronological order. For example, the service connector and/or the requesting service may keep track of the message sequence number it has seen before failure, and may ignore any messages which have a sequence number less than and equal to the sequence it has seen before failure. An exception may be raised by the message topic broker of the requesting service if the event log does not have the event for the sequence number expected by the service connector or if the message topic broker indicates that it has received a message with a sequence number that is not consecutive. In order to use the same event log for other services, a superset of all the proto fields will be taken to create a common format for an event record. The service connector will be responsible for filtering the required fields to get the ones it needs.

Other mechanisms can be used to implement an audit framework in other examples.

In some examples, the audit framework and event log may be tied to a particular FSVM and its own volume group. Thus, if an FSVM is migrated to another computing node, the event log may move with the FSVM and be maintained in the separate volume group from event logs of other FSVMs.

In some examples, the VFS 160 may be configured with denylist policies to denylist or prevent certain types of events from being analyzed and/or sent to the analytics system, such as specific event types, events corresponding to a particular user, events corresponding to a particular client IP address, events related to certain file types, or any combination thereof. The denylisted events may be provided from the VFS 160 to the analytics system in response to an API call from the analytics system. In addition, the analytics system may include an interface that allows a user to request and/or update the denylist policy, and send the updated denylist policy to the VFS 160. In some examples, the analytics VM 170 may be configured to process multiple channels of event data in parallel, while maintaining integrity and sequencing of the event data such that older event data does not overwrite newer event data.

In some examples, the analytics system may perform the metadata collection process in parallel with receipt of event data. The analytics system may reconcile information captured via the metadata collection process with event data information to prevent older data from overwriting newer data. In cases of reconciliation of the file system state caused by triggering an on demand scan, the state of the files index may be updated by both the event flow process and the scan process. To avoid the race condition, and maintain data integrity, when a metadata record corresponding to a storage item is received, the analytics system may determine if any records for the storage item exist, and if so, may decline to update those records. If no records exist, then the analytics system may add a record for the storage item.

The analytics system may process the metadata, event data, and configuration information to populate the analytics datastore. The analytics datastore may include an entry for each item in the VFS 160. In some examples, the event data and the metadata may include a unique user identifier that ties back to a user, but may not be used outside of the event data generation in some examples. In some examples, the analytics system may retrieve a user ID-to-username relationship from an active directory of the VFS 160 by connecting to a lightweight directory access protocol (LDAP) (e.g., for SMB, perform LDAP search on configured active directory, or on NFS, perform PDAP search on configured active directory or execute an API call if RFC2307 is not configured). In addition, rather than requesting a username or other identifier associated with the unique user identifier for every event, the analytics system may maintain a username-to-unique user identifier conversion table (e.g., stored in cache) for at least some of the unique user identifiers, and the username-to-unique user identifier conversion table may be used to retrieve a username, which may reduce traffic and improve performance of the VFS 160. Any mechanism to provide user context for active directory enabled SMB shares may help an administrator understand which user performed which operation as well as ownership of the file.

The analytics system may generate reports, including standard or default reports and/or customizable reports. The reports may be related to aggregate and/or specific user activity; aggregate file system activity; specific file, directory, share, etc., activity; etc.; or any combination of thereof. If multiple report requests are submitted at a same time and/or during at least partially overlapping times, examples of the analytics VM may queue report requests and process the requests sequentially and/or partially sequentially. The status of report requests in the queue may be displayed (e.g., queued, processing, completed, etc.). In some examples, the analytics system may manage and facilitate administrator-set archival policies, such as time-based archival (e.g., archive data based on a last-accessed date being greater than a threshold), storage capacity-based archival (e.g., archiving certain data when available storage falls below a threshold), or any combination thereof.

Although some examples for generating and providing metadata and event data are described herein, other mechanisms for obtaining and/or communicating metadata and/or event data from a file server may be used in other examples.

In some examples, the analytics system may be configured to analyze the received event data to detect irregular, anomalous, and/or malicious activity within the file system. For example, the analytics system may detect malicious software activity (e.g., ransomware) or anomalous user activity (e.g., deleting a large amount of files, deleting a large share, etc.).

Examples of analytics systems described herein may be implemented as a cloud-based, data analytics system. A customer using a file system for storage can use the analytics system to get insights and information about their data. This includes information like, most active users, most accessed files, the overall age of the data, etc. One of these aspects includes auditing information (e.g., what operations—such as reads, writes, creates, deletes, renames and metadata attribute changes—were performed by users on various files). This information can have a variety of uses. For example, if a user wants to know who created or deleted a file, or if some specific user has unusual access patterns. But, for this information to be meaningful, the user would need to know what file is being talked about. For one, the path identifies the location of the file in the system, which may not be resolvable from just the name. Furthermore, it is not uncommon for people to repeat folder and file names on their system. As a simple example, many coding projects have a file called README.md. So just telling a user that a write happened on a file called README.md, might not be enough for the user to determine which one is being talked about. So by displaying the complete path of the file, analytic s systems described herein can specify precisely which file is being referenced and allow the user to directly locate it in their system. Accordingly, the complete file path may be advantageous in the system. If an analytics system does not specify the complete path, the user might find it hard (or even impossible) to find out precisely which file is being described.

Examples of analytics systems may construct and/or reconcile file system paths and/or directory structures (e.g., trees) based on node and/or file ID number (e.g., inode number) in some examples. Analytics systems and applications may accordingly construct and manage a file system namespace based on an object inode number.

Generally, a path may refer to a file system path that uniquely determines the location of an object (e.g., a file or folder) in the file system. One example is: /usr/Documents/Imp_doc s/p as sport.pdf

To effectively convey analytics information to a user, the complete path of the file or folder in question is a must as the complete file or directory path allows a user to uniquely determine the location of the object. To generate paths the path of a parent directory may be appended to its children (files or folders in it) to get the path of the children. This process of querying a directory for its children and appending the paths can be iterated by traversing the file system in a breadth-first or depth-first search manner and all paths in a system can be generated.

However, in file analytics systems, analytics may be based on metadata received from one or more file systems. These metadata scan events may not contain the entire file path, nor in some examples may they contain the list of children for a directory. However, metadata information received from file systems in data sources may contain a unique identifier for an object's immediate parent directory.

Additionally, to keep metadata up to date with the actual file system, file audit events (like a create, move, or rename) received from the file server need to be processed and the paths need to be updated accordingly. This can create additional complexities—moving a directory that has subdirectories or subfolders will require updating the paths of all its children (and grandchildren and so on).

Furthermore the user may trigger new metadata scans (e.g., an on demand scan) which then could lead to the system receiving conflicting information (from a scan and from a later audit event, for example) that it needs to choose between.

Example file analytics systems described herein may efficiently store and query the path for all objects in the file system.

Paths may be stored only for directory objects. File paths may not be stored in their complete path form. Rather, an immediate parent directory for the file may be stored, and the complete path reconstructed with reference to the parent directory path. Example analytics systems efficiently compute the path of a file by querying the path of its parent. This may massively reduce storage requirements (the number of files in a system is typically much more than the number of directories in the system).

In some examples, the data is on an SQL database and two distinct SQL queries may be used to generate the folder paths. One SQL query may be used to generate the first (top-most) level of paths, and a second to generate the next level (one lower) given the paths of a higher level. Thus, paths may be generated in a level-order fashion.

Using a single query in some examples allows the system to checkpoint progress and recover from a left off point. Each query runs atomically (e.g., it either completes or does not change anything). So if the system shuts down after generating paths after level 10, it can simply pick up from there and process level 11 in the next run.

When processing an on-demand scan's data, to avoid the possibility of inconsistent data from the scan and audit events, the system may simply halt audit event processing, process the scan data, and replay audit events that occurred in the interim. This ensures that the system returns to a consistent state immediately after scan data is processed.

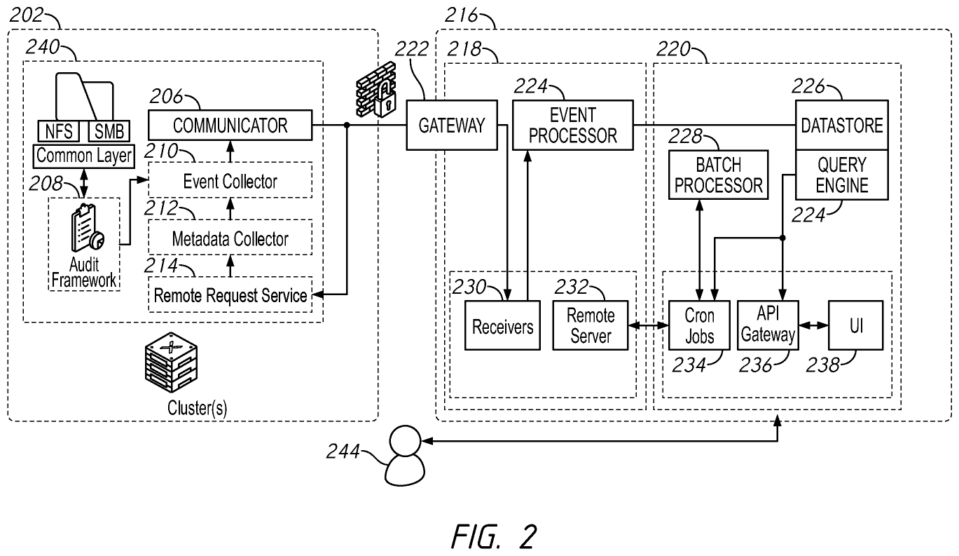

FIG. 2 is a schematic illustration of an analytics system in communication with a file server arranged in accordance with examples described herein. The system includes a file server 202 in communication with analytics system 216. The file server 202 includes FSVM 240. The FSVM 240 may include protocol layer 204, communicator 206, audit framework 208, event collector 210, metadata collector 212, and remote request service 214. The file server 202 may be hosted on a cluster of computing nodes. The analytics system 216 may be a hosted system on one or more cloud service providers. The analytics system 216 may include gateway 222, virtual network 218, and virtual network 220. The virtual network 218 may include event processor 224, receivers 230, and server 232. The virtual network 220 may include batch processor 228, datastore 226, query engine 244, job scheduler 234, API gateway 236, and user interface 238.

The components shown in FIG. 2 are exemplary. Additional, fewer, and/or different components may be used in other examples. Examples of the analytics system 216 are described herein as provided on AMAZON WEB SERVICES (AWS), although other cloud providers may be used in other examples. The file server 202 is illustrated as including an FSVM (e.g., FSVM 240), however, other file servers which may not include FSVMs may be used in other examples.

The file server 202 of FIG. 2 may be implemented by file servers described herein, such as the virtualized file server described with reference to FIG. 1A and FIG. 1B. For example, the FSVM 240 may be implemented by, or used to implement, one or more of the FSVMs 160, 162, or 164 of FIG. 1A. However, in other examples, other file servers may be used to provide metadata and event data to the analytics system 216.

File servers may collect metadata and event data and provide the metadata and event data to file analytics systems described herein. The metadata for a file system provided by a file server generally may include overall size, structure, and storage locations of parts of the file system managed by the file server, as well as details for each data item (e.g., file, folder, directory, share, owner information, and/or permission information). The details for each data item may include, for example, an identification of the data item, size, name, file type, owner, and/or permissions information. The metadata may be used by file analytics systems described herein to provide analytics regarding the file system. In the example of FIG. 2, the metadata may be collected by metadata collector 212 which may be a service operating within the FSVM 240. The metadata collector 212, for example, may be software (e.g., executable instructions configured to be executed by one or more processors of a host machine hosting the FSVM 240, for example). In some examples, the file server 202 may include a cluster of FSVMs, and each FSVM may include a metadata collector which may collect the metadata of the share, or portion of share, that is associated with that FSVM. The metadata from each FSVM may be communicated to the analytics system from each FSVM, and/or the metadata from each FSVM may be communicated to a leader FSVM on a leader node and provided to the analytics system. The metadata collector 212 may scan the file system, or a portion of the file system accessible to the FSVM 240, and may collect metadata associated with the files in the file system. Other mechanisms may be used to gather file system metadata in other examples.

Example file servers may include event collector(s), such as event collector 210 of FIG. 2. The event collector 210 may be implemented as software (e.g., executable instructions configured to be executed by one or more processors of a host machine hosting the FSVM 240, for example). File servers may utilize event collector(s) to record events that effect the file system. Examples of events include add, move, delete, modify, and rename. An event record may be made for each event which may include an identification of the item associated with the event (e.g., a file, folder, share), a user associated with the event, and an event time. Other attributes of the event may be included in the event record in other examples. In the example of FIG. 2, the event collector 210 may generate the event record and may include events for a share or portion of share associated with the FSVM 240. The event data from each FSVM may be communicated to the analytics system from each FSVM and/or the metadata from each FSVM may be communicated to a leader FSVM on a leader node and provided to the analytics system.

In some examples, the file server may act to collect and/or transmit metadata and/or event data at the request of the analytics system. For example, the file server 202 may perform a metadata scan responsive to a request from analytics system 216. The remote request service 214 may be provided in the file server 202 to receive a request from the analytics system 216, which may be, for example, an API call, to initiate a metadata scan and/or to provide event data. The metadata collector 212 and/or event collector 210 may act in response to a request from analytics system 216 to perform a metadata scan and/or to provide event data. The analytics system 216 may request a metadata scan and/or may request event data using remote request service 214 in some examples.

File servers described herein may accordingly provide one or more file systems. A file system generally refers to an arrangement of files in folders which may be accessed in accordance with a namespace. For example, a path in the namespace may be used to access a particular file. Generally file servers described herein may have an ability to receive and respond to requests formulated in accordance with a file server protocol, such as NFS and/or SMB. So, the example file server 202 in FIG. 2 may include protocol layer 204. The protocol layer 204 may include an ability to receive an NFS and/or SMB request for files. In some examples, a common layer may be provided in the protocol layer 204 which may allow for the receipt of both NFS and SMB requests to access the namespace of files provided by the file server.

File servers described herein may include an audit framework, such as audit framework 208 of FIG. 2. The audit framework 208 may be one or more software services provided by the audit framework 208, such as by the FSVM 240 of audit framework 208. The audit framework 208 may include a dedicated event log (e.g., tied to an FSVM-specific volume group). The event log may be capable of being scaled to store all event data records and/or metadata for a particular FSVM or other portion of the file system, and may be stored according to a retention policy. The audit framework may include an audit queue, an event logger, an event log, and a service connector. The audit framework may receive event data records and/or metadata from the file server and to provide the event data records and/or metadata to the event collector 210 and/or metadata collector 212. In some examples, the event data records may be stored with a unique index value, such as a monotonically increasing sequence number, which may be used as a reference by the requesting services to request a specific event data record. The event logger may keep the in-memory state of the write index value in the event log, and may persist it periodically to a control record (e.g., a master block). When the audit framework is started or restarted, the master record may be read to set the write index.

File servers described herein may include a communication component, such as communicator 206. The communicator 206 may be implemented using a software service operating on a host machine that forms part of the file server 202. The communicator 206 may provide event and/or metadata to the analytics system 216. For example, the communicator 206 may provide data from the event collector 210 and/or metadata collector 212 to the analytics system 216. The communicator 206 may connect to the analytics system 216 over a network, such as the Internet. For example, the analytics system 216 may be a hosted solution residing in a cloud service provider, and the file server 202 may be an on premises file server which may communicate with the cloud service provider using communicator 206.

In this manner, during operation of a file server, metadata and event data regarding files and other items in a file system may be collected by the file server. The metadata and/or event data may be provided to an analytics system, such as the analytics system 216 of FIG. 2. The analytics system 216 may receive the metadata and/or events data at a gateway 222.

Analytics systems described herein may include one or more receiver processes, such as receivers 230 of FIG. 2. The receivers 230 may receive the metadata and/or event data provided by the file server through the gateway 222. Metadata and/or event data may be provided to an event processor 224. The event processor 224 may be implemented using a software process in the hosted cloud environment. For example, the event processor 224 may be implemented using AWS KINESIS and/or AWS LAMBDA. The event processor 224 may process a data stream from the file server and store metadata in a datastore, such as datastore 226. The metadata may be used, for example, to create a record in datastore 226 for each item in the file system. The records in the datastore 226 may be updated by the event processor 224 in response to event data from the file server.

Accordingly, file analytics systems described herein may maintain a datastore, such as datastore 226 of FIG. 2, which may contain records corresponding to data items in a file system. The records may be populated using metadata from the file system, and may be updated (e.g., maintained) based on event data from the file system. For example, a rename event from the file system may cause the event processor 224 to update a name of a data item in the datastore 226 in accordance with the event. The records in the datastore 226 may include, by way of example, an ID of the item (e.g., an inode number), a name, size, file type, owner, and most recent user. Other information may be included in other examples. In some examples, the datastore 226 may additionally or instead include a record associated with each event received from the file system. For example, the datastore 226 may include a record of an event including an ID of a data item (e.g., a file) involved in the event, a type of event, and updated information regarding the data item following the event (e.g., new name and/or location). The datastore 226 may be implemented using a database in some examples (e.g., an elastic search database). In some examples, the datastore 226 may be implemented using a data warehouse. For example, SNOWFLAKE may be used to implement datastore 226 in some examples.

A data warehouse generally refers to a data management system that may be used to store enterprise data and provide an analytical processing function to access the data. Accordingly, query engine 244 is depicted in FIG. 2 to represent processing functionality that may be used to query, access, write, or otherwise manipulate data in the datastore 226. The query engine 244 may be integral to the datastore 226 in some examples. The query engine 244 may be implemented using software, such as in a virtual machine or container or other virtualized computing system provided by a cloud provider. The query engine 244 may be implemented using computer readable media encoded with executable instructions which, when executed, cause one or more processors to perform the query engine functionality described herein. Generally, the query engine 244 may provide an analytical processing function of a data warehouse, including an ability to iteratively query the data in the data warehouse. A data warehouse may include a relational database and extraction, loading, and/or transformation software processes to prepare data in the data warehouse for analysis. The data warehouse may provide other functions for querying and/or analyzing data in some examples. Generally, a data warehouse may not include traditional indexes that may historically be used in relational databases to speed up access to the data. Rather, a system of iterative queries may be used to access the data in a data warehouse. These iterative queries and other functionality may be performed by query engine 244 in some examples.

Examples of analytics systems described herein may include a batch processor that may be utilized to execute batch operations on the file system based on the metadata and event data obtained by the file analytics system. For example, the analytics system 216 of FIG. 2 includes batch processor 228. The batch processor 228 may be implemented using AWS BATCH, for example. The batch processor 228 may be a software service that facilitates batch operations using data from the datastore 226. In some examples, the jobs that may be executed by the batch processor 228 are generated and/or scheduled by a scheduler, such as job scheduler 234 of FIG. 2.

Examples of analytics systems described herein may include a user interface. For example, the analytics system 216 of FIG. 2 may include user interface 238. The user interface 238 may allow a user, such as user 242 of FIG. 2, to access one or more reports or data based on data in the datastore 226. The user interface 238 may include a display and/or one or more input and/or output device(s) including an interface to receive text and/or click or other touch inputs. The user 242 may be a human user and/or may be one or more other software processes or computing systems which may interact with analytics system 216.

Examples of analytics systems and methods described herein may generate path names for objects in file systems. It may be desirable, for example, to present a full path name of a file, folder, share, or other object when presenting analytics information. The full path name may be useful, for example, in identifying (e.g., uniquely identifying) a file, folder, share, or other object. File or folder names may be duplicated throughout the file system, but a path may identify a particular file, folder, or share. The path generally includes a list of folders (e.g., directories) in which a particular file or object resides. However, path names may not be provided as metadata and/or event data received from a file system described herein. For example, the file server 202 of FIG. 2 may not provide path names to the analytics system 216 for objects in a file system provided by the file server 202. The path names may not be included in metadata collected by metadata collector 212 and/or events collected by event collector 210 and/or data communicated by communicator 206, for example. Instead, the metadata and/or event data may include an identification of an object in the file system, together with an identification of a parent object in the file system. Examples of analytics systems and methods described herein may utilize this information to generate (e.g., reconstruct) complete path names for objects in the file system. Examples described herein may generate the path names in a computationally efficient manner, which may allow for operation in systems analyzing millions of objects or more. Accordingly, examples of analytics systems described herein may generate and/or maintain paths for objects in a file system. The paths may be stored in a path table. Overall, paths may be generated for folders at an initial scan time (e.g., using metadata), and analytics systems described herein may monitor audit logs for events impacting the path table—e.g., create and rename events—and update the path table in accordance with the event data.

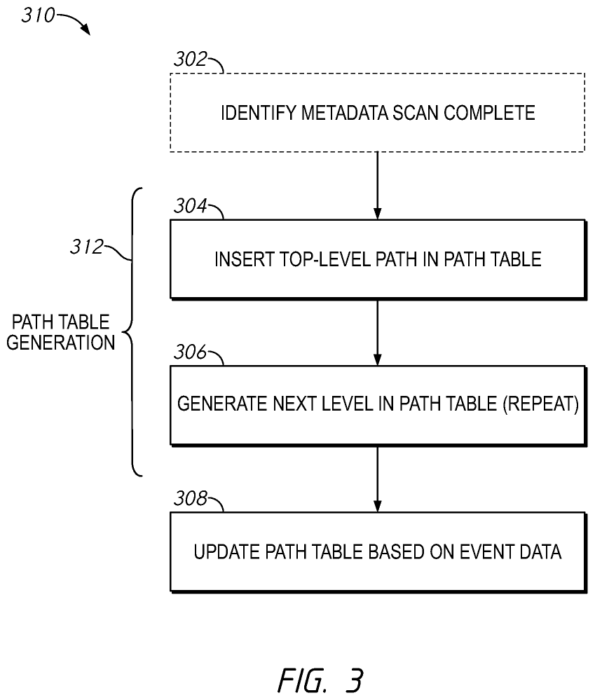

FIG. 3 is a flowchart illustrating a method for generating path names for file system objects arranged in accordance with examples described herein. Method 310 includes block 302, which recites “identify metadata scan complete.” Following block 302 are blocks that may be used to perform path table generation 312. Path table generation 312 may include block 304, which recites “insert top-level path in path table.” Following block 304, and also included in path table generation 312, is block 306, which recites “generate next level in path table”. Block 306 may be repeated for each level of a file system directory structure. Following block 306 is block 308 which recites “update path table based on event data.”

The blocks of FIG. 3 are exemplary only. Additional, fewer, and/or different blocks may be used in other examples to generate and/or maintain a path table described herein. The method 310 of FIG. 3 may be performed by analytics systems described herein, such as by analytics system 216 of FIG. 2. For example, the query engine 244 may be used to perform queries of the datastore 226 to perform block 304, block 306, and/or block 308 of FIG. 3. Moreover, the path table generated and/or maintained by the method 310 of FIG. 3 may be stored in datastore 226 in some examples.

Accordingly, analytics systems and methods described herein may be utilized to generate and/or update a path table. While referred to as a table, the path table may generally be stored using any type of data structure. The path table may include any of a variety of attributes for each object. The path table may store, for each folder object, the object ID and the path name. The path table may store, for each file object, the object ID and the parent folder object ID. Note that, in this manner, a complete path may not be stored for each file, but rather for each folder. This may reduce storage requirements for the path table. Examples of attributes that the path table may store for each object in the path table include object identifier (object ID), object path, share identifier (share ID), active indicator, and/or update date. In some examples, the path table may additionally include object name, object type, and/or file type. Other attributes may be included in other examples.

The object ID refers to a unique identifier for the object (e.g., file or folder). Examples of object IDs include inode numbers. In other examples, other numbers or identifiers may be used. The path name may be a resolved path from the share root. Generally, a path name (also referred to simply as a ‘path’) includes a root directory and each additional folder in a tree or other organizational structure between the root and the object—e.g., //root/folder1/folder3 or //root/folder1/folder3/folder9/folder7. The number of folders, including the root, in the path name may be referred to as a length or a depth of the path. Each folder may be referred to as a level in the path name. The share ID may be a unique identifier for a share. Each share may have its own set of paths or directory structures. Object IDs may be unique within a share in some examples. An object ID may be repeated in a different share in some examples. An active indicator generally refers to a flag (e.g., a bit) that is indicative of whether the object is currently in the file system. For example, the flag may be in one state if the object is in the file system, and in another state if the object has been deleted from the file system. In this manner, the path table may include old objects which may no longer be in the file system. The update date may be a timestamp of a last time the path was updated. The update date may be a zero or NULL value in some examples after initial path generation based on a metadata scan, but may be updated based on subsequent event data and/or on demand metadata scans.

Accordingly, methods described herein may generally include generating an initial path table based on metadata received at an analytics system from a file server. The methods may additionally or instead include updating the path table based on event data from the file server. The initial path table may be generated by an initial metadata scan. To generate the initial path data, in some examples, systems and methods described herein may first determine that a metadata scan is complete, such as in block 302 of FIG. 3, where a system may identify that a metadata scan is complete. It may be desirable to ensure that the metadata scan is complete—e.g., metadata received from a file server has all been received by the analytics system 216 and/or stored in the datastore 226. This may be desirable because it may be advantageous to generate file paths once a complete set of metadata is obtained, to avoid missing information or a need to add information at a later time.

In some examples, the analytics system 216 of FIG. 2 may identify that the metadata scan is complete. In some examples, an initial metadata scan may be performed, for example, when a file server, such as file server 202 is subscribed with, or initially in communication with, an analytics system, such as analytics system 216. The analytics system 216 may request the initial scan, for example through remote request service 214, and/or the initial scan may occur automatically. The file server 202 may scan initial metadata of one or more file systems provided by the file server 202 and may provide the metadata to the analytics system 216, for example using communicator 206 to provide the data to gateway 222.

In some examples, the analytics system 216 may store a status of a metadata scan in a data structure (e.g., a table). The data structure, such as a scan status indicator, may be stored, for example in datastore 226 and/or another location accessible to analytics system 216. When the scan status indicator has a value indicative of the scan being complete, the analytics system 216 may initiate generation of initial paths, in some examples. In some examples, the indicator of the scan being complete may reflect that the metadata has simply been received by the analytics system 216 (e.g., by receivers 230 and/or event processor 224). The metadata may not yet have been stored into datastore 226. Accordingly, in some examples, the analytics system 216 may wait until a predetermined amount of time (e.g., one minute, two minutes, three minutes, four minutes, and/or five minutes in some examples) has elapsed after the scan status indicator is indicative that the scan has completed.

In some examples, block 302 to identify that a metadata scan is complete may accordingly be implemented using a scan status data structure (e.g., a scan status table). In some examples, a task may be executed by the analytics system 216 (e.g., in the virtual network 218 and/or virtual network 220). The task may monitor a stream on a scan status data structure. When an initial scan is requested, an entry may be created in the scan status data structure with a status indicating the scan is not yet complete (e.g., ‘queued’ or ‘in process’). When the scan is complete, the entry may be updated so that the scan status table indicates the status is complete. Once the scan status is indicative of being complete, a task table entry associated with the task may be updated to a ready state. Note that there may be one task per share of a file system. Accordingly, a complete entry in the scan status table may indicate that a scan of the share is complete. A ready state of a task associated with the share may indicate that the scan of the share is complete. The analytics system 216 may execute another task, which may not be a task on a stream. The task may run periodically and call a procedure for initial path generation. The procedure for initial path generation may check that an entry in the task table is indicated as ready and/or an entry in the scan status table is indicated as complete. Additionally, in some examples, the procedure may check that at least a predetermined time (e.g., 5 minutes) has passed since the entry indicated completion. Once the task determines that the scan for a share is complete (e.g., the scan status table indicates completion and more than a predetermined period of time has elapsed), initial paths for that share may be generated.

Initial path generation may occur using block 304 and block 306 of FIG. 3. In block 304, top-level path(s) may be inserted into the path table. Path generation may be performed, at least in part, using query engine 244 of the analytics system 216 of FIG. 2, and the query engine 244 may query the datastore 226. Recall the datastore 226 may include metadata for one or more file systems, including an identification of each object, and an identification of the parent object of each object. Top-level objects may have an object identification (object ID) that is equal to the parent object ID. Accordingly, in block 304, the query engine 244 may query the datastore 226 for records where the parent object ID equals the object ID. A record may be made in a path table for each returned top-level record in the datastore 226. For a top-level object, the path may be simply the object name.

Initial path generation may proceed using block 306 of FIG. 3. In block 306, a next level may be generated in the path table. In some examples, the next level may be generated using an induction process that may occur using sub-queries. Using a maximum path depth that has been recorded in the path table (e.g., 1 at the time only the root level has been recorded in the path table), a first sub-query may select all object IDs and paths in the path table having the maximum path depth to provide a group of maximum existing path records. In another sub-query, the query engine 244 may select all object records from the metadata scan which are not top-level records to provide a group of records at a lower level than the top level. A record from this metadata table group may be joined to a record from the group of maximum existing path records when a parent object ID from the metadata table group equals the object ID of the group of maximum existing path records. New paths resulting from the joining are added to the path table. The block 306 of FIG. 3 may be repeated for each level of a file system tree until no more records are added. For example, the datastore may be repeatedly queried for increasing next path levels. In some examples, the repeated querying may continue until no objects are returned to a last query. Note that each query execution may be atomic. This may advantageously allow the analytics system 216 to resume the path generation process following an arbitrary stop. This top-down approach to path generation may be computationally efficient for querying the datastore. In one example using metadata corresponding to 3 million directory records, total execution time was 3 minutes to generate paths in the path table for all folders.

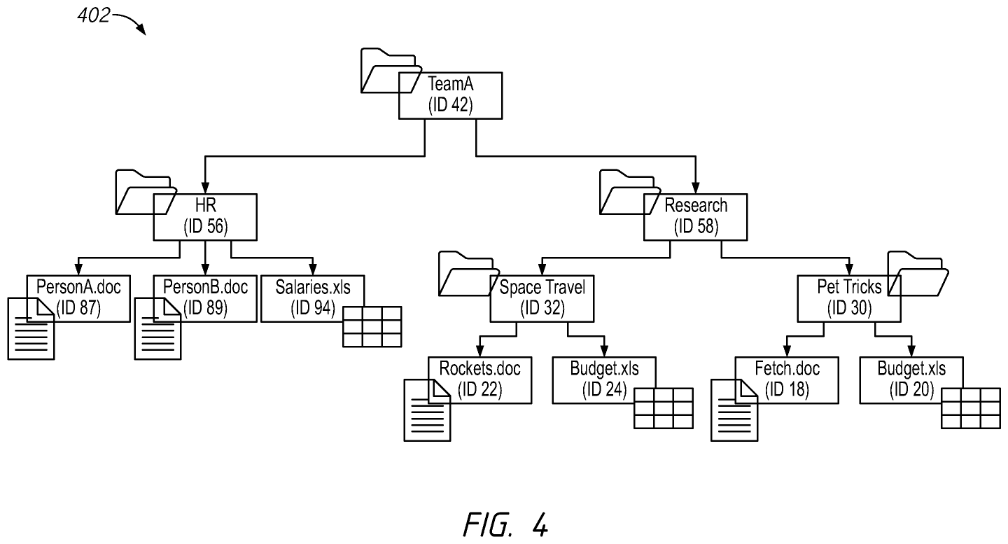

FIG. 4 is an example of a share of a file system arranged in accordance with examples described herein. A single share 402 is shown in FIG. 4. The share 402 is depicted as including a variety of files and folders. Each file and folder has an identification number (ID number). The ID number in some examples may be implemented using an inode number. In the example of FIG. 4, a root directory (e.g., folder) is named TeamA and has ID 42. The root directory has two folders at a first level beneath the root directory. The two folders are HR, which has ID 56, and Research, which has ID 58. The folder HR has three files in it. The three files are PersonA.doc, which has ID 87, PersonB.doc, which has ID 89, and Salaries.xls, which has ID 94. The folder Research has two sub-folders—Space Travel, which has ID 32, and Pet Tricks, which has ID 30. The folder Space Travel has two files in it, Rockets.doc, which has ID 22, and Budget.xls, which has ID 24. The folder Pet Tricks has two files in it, Fetch.doc, which has ID 18, and Budget.xls, which has ID 20.

The share 402 of FIG. 4 may be provided by the file server 202 of FIG. 2 in some examples. The directories, folders, and files depicted in FIG. 4 are exemplary only, and generally represent a simplified example provided for the purpose of illustration and ease of illustrating the path generation techniques described herein. It is to be understood that any number of root directories, folders, and files may be used, including any number of sub-folders, and any file types. In practice, systems and methods described herein may be utilized with shares and file systems having any number of directories and files—including tens, hundreds, thousands, millions, tens of millions, and/or hundreds of millions of files and/or folders. Computational usage associated with manipulating data associated with the files and/or folders may accordingly be quite large in some examples.

During operation, metadata associated with the share 402 may be provided to an analytics system—such as by file server 202 providing the metadata to analytics system 216.

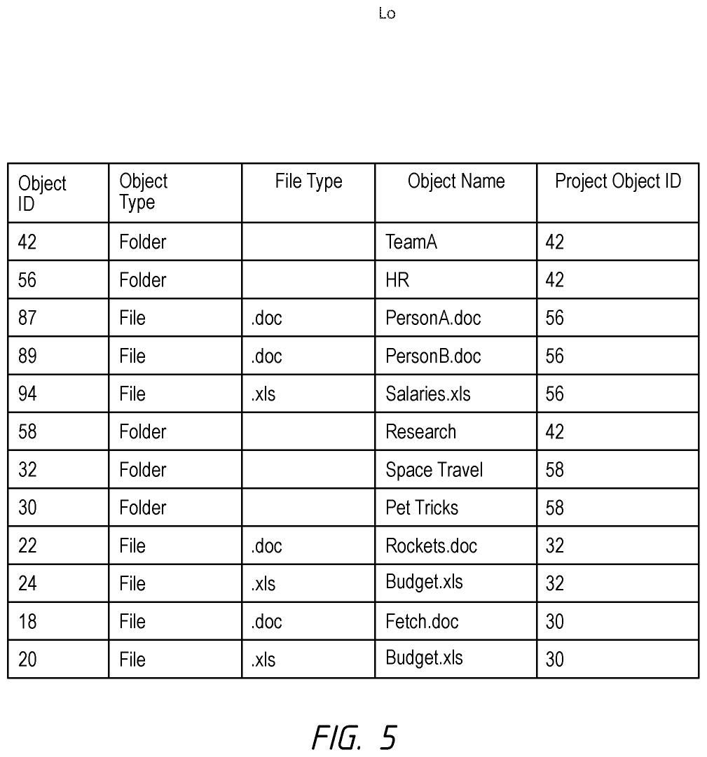

FIG. 5 is an example of metadata associated with the share 402 of FIG. 4, arranged in accordance with examples described herein. The metadata of FIG. 5 may include object ID, object type, file type, object name, and parent object ID. Additional, fewer, and/or different attributes may be used in other examples. The metadata of FIG. 5 may be provided by the file server 202 of FIG. 2 to the analytics system 216 in some examples, and may be stored in datastore 226. In particular, note that the table contains object ID and parent object ID, but not a complete path for each record.

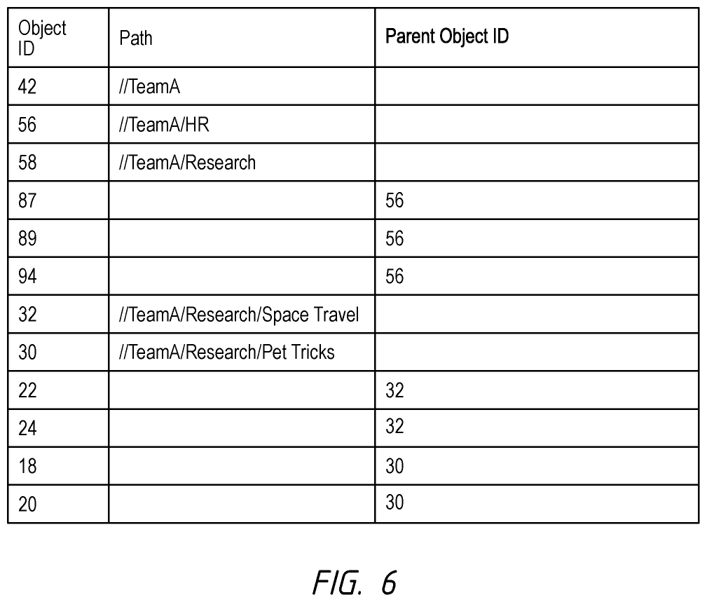

An example of the operation of the path generation of FIG. 3 can be described with reference to the example share of FIG. 4 and metadata of FIG. 5. An example data path structure (e.g., data path table) which may be created using path generation techniques described herein is illustrated in FIG. 6. Recall in block 304 of FIG. 3, top-level paths may be inserted into the data path table by querying the datastore for metadata records where the object ID was equal to the parent object ID. Accordingly, reviewing FIG. 5, the query for top-level paths would return objectID 42 (e.g., the top-level folder TeamA). Accordingly, an entry in the path table may be made indicating the path for object ID 42 is simply the object name—TeamA.

In block 306 of FIG. 3, next-level paths may be identified. In a first sub-query, the path table of FIG. 6 (which at this time may only include top-level object ID 42), is queried to identify objects having a path length of one. Accordingly, the query engine 244 of FIG. 2 may perform this query on the metadata of FIG. 5, and object ID 42 may be returned. In another sub-query the metadata of FIG. 5 may be queried to return non-top-level records—the query engine 244 would return all records but object ID 42. The query engine may match the records returned to the first group when their parent object ID matched an object ID in the first group (e.g., object ID 42 in this example). Accordingly, the query engine may join records for Object ID 56 and Object ID 58 to the object ID 42. So, for object ID 56, the full path becomes //TeamA/HR (e.g., joining the parent object ID path to the name of the identified child record). For object ID 58, the full path becomes //TeamA/Research.

Block 306 of FIG. 3 may be repeated for a next level. The path table of FIG. 6 may be queried to identify objects having a path length of two. Object ID 56 and object ID 58 are returned. These are again joined to the non-top-level records of metadata when the metadata has a parent object ID equal to one of these second-level object IDs. Accordingly, reviewing FIG. 5, object ID 87, object ID 89, and object ID 94 all have the parent object ID 56, and may be considered for joining; however, the query engine may identify that all these object IDs are files (not folders) in accordance with their object type entry in the metadata. Accordingly, the query engine may not generate a full path, but may insert the parent object ID for the record into the path table. The query engine 244 may identify object ID 32 and object ID 30 as having the parent object ID 58. Accordingly, the query engine may join the paths of object ID 58 to the name of object ID 32, resulting in the path name //TeamA/Research/Space Travel. The query engine may also join the path of object ID 58 to the name of object ID 30, resulting in the path name //TeamA/Research/Pet Tricks. These entries may be inserted into the path table by the query engine.

Block 306 of FIG. 3 may be repeated for a next level. The path table of FIG. 6 may be queried to identify objects having a path length of three. The query engine may return object ID 32 and object ID 30 as having a path length of three. The query engine may identify object ID 22, object ID 24, object ID 18, and object ID 20 as having one of these object IDs with path length of three as a parent object ID. However, the query engine may identify that object ID 22, object ID 24, and object ID 18 are all files (not directories), and accordingly may not join them, but may simply store the parent object ID for each in the path table. A representation of the resulting data path data structure (e.g., data path table) is shown in FIG. 6.

Accordingly, analytics systems described herein may generate path tables based on metadata received from a file server. A path table may include a full path name for folders in a file share. The path table may include parent object IDs for files in the file share. In this manner, a data structure may be generated which allows for efficient access to path names for objects.

Examples of analytics systems described herein may maintain path tables using event data received from a file server. For example, the analytics system 216 may maintain a path table, which may be stored in datastore 226. The analytics system 216 may maintain the path table based on event data received from the file server 202. Accordingly, the analytics system 216 may provide a process, e.g., an updation process, which may execute, for example, on virtual network 218 and/or virtual network 220. For example, the updation process may be executed on a virtual machine and/or container, and may be implemented in software (e.g., executable instructions which may be executed by one or more processors to perform the updation process).

In some examples, the updation process (which may also be called an update process) may determine that initial and/or on demand metadata scans have been completed. For example, the updation process may reference the scan status table and/or task table used to track the status of metadata scans. When a metadata scan is indicated as complete, or the task table indicates the task status is ready, that may indicate a scan of a particular share has been completed. Accordingly, the updation process may wait a predetermined amount of time before initiating updation operations, to ensure that a further scan of another share is not initiated. In some examples, the updation process may wait 10 minutes, 20 minutes, 30 minutes, or some other period of time after determining a metadata scan is complete to begin operations. When the updation process determines the metadata scans have completed, the updation process may begin maintaining the path table. In this manner, the updation process may not be operating in some examples during a metadata scan and in some examples may not be operating before a path table is generated based on all metadata received from the file server. This may aid in some examples in reducing data errors or conflicts in the path table from attempts to update the table based on metadata and also based on event data. Instead, in some examples, the analytics system may first generate the path table based on metadata, and then may update or maintain the table using the updation process. The updation process may also be halted during performance of an on demand metadata scan in some examples.

The updation process may update the path table in accordance with events received from the file server. For example, an updation process provided by analytics system 216 may update a path table stored in datastore 226 based on events received from file server 202 and processed by event processor 224. Examples of events that may affect the path table include directory created, directory deleted, and rename. Responsive to an event indicative of a directory created, the updation process may create a new entry in the path table for the new directory. The directory's object ID and full path may be stored in the new entry in the path table. In some examples of event data, such as SMB audit records, a full path name may be provided in the event data, and that path name may be used by the updation process to update the path table. In some examples, the path name may not be included in the event data, such as in examples of NFS records. In examples where the path name is not in the event data, the updation process may query the path table for a parent object ID corresponding to the new directory. The parent object ID may be included in the event data. The name of the created directory may be appended to the path for the parent object ID. Responsive to an event indicative of a directory deleted, the updation process may mark the corresponding entry(ies) in the path table as inactive. For example, a flag may be included in the path table for each record, indicating whether the record is active or inactive. Responsive to an event indicative of a rename, entries for the renamed object and all sub-directories may be modified by the updation process.

The updation process may update the path table responsive to a directory rename event—e.g., a move of a directory. In some examples, a folder may be moved (e.g., from one folder into another folder higher or lower in a hierarchy of the file system). The movement of one folder may cause modifications to the paths of multiple other objects—such as all sub-folders. It may be computationally difficult to modify all affected records in the path table. In examples where the path table is stored in a data warehouse, the path table may not be indexed for efficient querying of the path name. Accordingly, in some examples, the updation process may update the path table using a prefix search. The updation process may query the path table for all entries having a path with a prefix equal to the path of the moved directory (before it moved). The prefix of all those records is replaced with the new path of the moved directory.

As an example, referring back to FIG. 4, consider a situation where the Research folder is moved into the HR folder. Accordingly, the initial path for the Research folder was //TeamA/Research/. After the move, the path for the Research folder is //TeamA/HR/Research. Responsive to an event indicating the movement of the Research folder, the updation process may query the path table of FIG. 6 for records having a path prefix of //TeamA/Research (records corresponding to object ID 58, object ID 32, and object ID 30). The prefix in all records may be updated to //TeamA/HR/Research. Accordingly, the final path for object ID 58 will be //TeamA/HR/Research. The final path for object ID 32 will be //TeamA/HR/Research/Space Travel. The final path for object ID 30 will be //TeamA/HR/Research/Pet Tricks. Note that renames (e.g., movement) of objects does not cause the object ID of the object to change—the object ID remains constant regardless of the location of the object in the file system. For example, the object ID may be an inode number. In this manner, the path table may be efficiently updated responsive to a moved directory. Note that no change is needed to the path table for the files in the Space Travel or Pet Tricks folders, because those files retain their same parent object IDs.

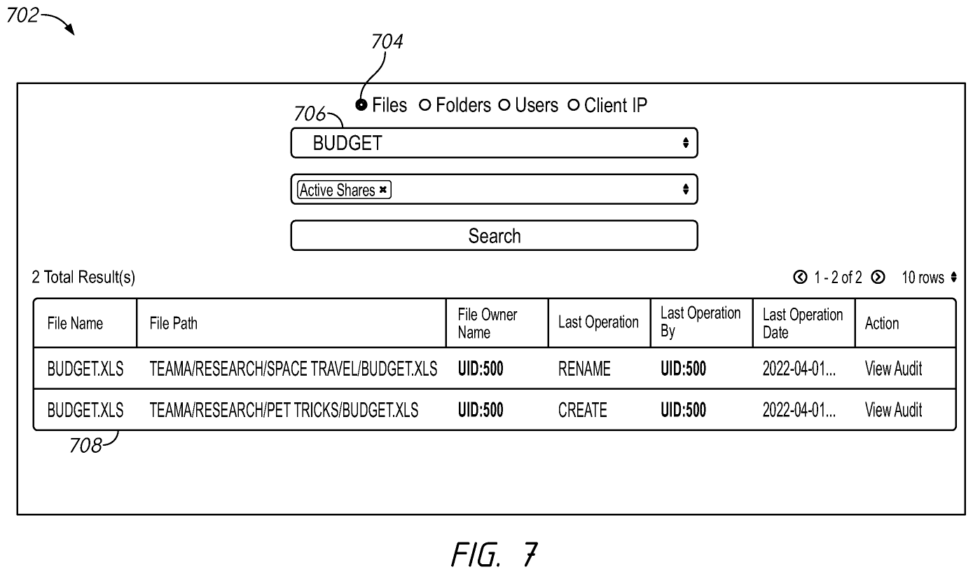

FIG. 7 is an example user interface which may be provided by file analytics systems described herein. The user interface 702 in FIG. 7 includes a selector 704 to select a search category, an entry field 706 to enter search term(s), and displays results 708. The layout and attributes of the user interface 702 are exemplary, and additional, fewer, and/or different attributes may be present in other examples. The user interface 702 may be implemented using file analytics systems described herein, such as the analytics system 216 of FIG. 2. For example, the user interface 702 may be implemented by and/or used to implement the user interface 238 of FIG. 2. The user interface 702 may be displayed on a display, and input devices may be used to select the selector 704 and enter term(s) in the entry field 706.

Generally, file analytics systems described herein may be used to provide information regarding file systems—including information regarding the objects in the file systems. In the example of FIG. 7, an example search is shown based on the example file system of FIG. 4. In the example of FIG. 7, a user has entered “budget” into the entry field 706 and has selected selector 704 to search for files in the file system. The file analytics system may accordingly access metadata and/or event data, such as stored in the datastore 226, to provide results 708. In the example of FIG. 7, the results include, for each object responsive to the search, a file name, file path, file owner name, last operation, last operation by, and last operation date. Other or different results may be presented in other examples. However, note that the path of the file may be provided. The analytics system may retrieve the path from a path table maintained by the analytics system in accordance with examples described herein. Accordingly, in the example of FIG. 7, the file analytics system may return two entries in the file system having files with the name budget. One has the file path //TeamA/Research/Space Travel/Budget.xls, and another has the file path //TeamA/Research/Pet Tricks/Budget.xls. In this manner, a user may view where the files are located in the file system, and may be able to better understand files with duplicative names. The results 708 of FIG. 7 also indicate the file owner name, last operation, last operation by, and last operation date associated with the files. This information may be retrieved by the file analytics system from the metadata and/or event data retrieved from the file server. By generating and updating path tables in accordance with methods described herein, the path information may be efficiently included in results provided by file analytics systems.

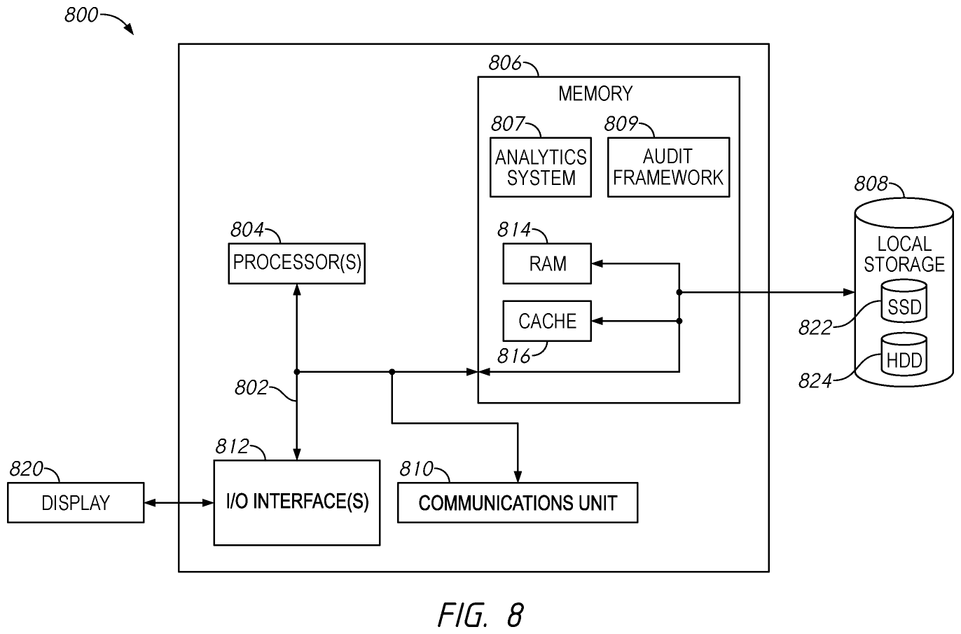

FIG. 8 depicts a block diagram of components of a computing node (e.g., computing device or computing system) 800 in accordance with embodiments of the present disclosure. It should be appreciated that FIG. 8 provides only an illustration of one implementation and does not imply any limitations with regard to the environments in which different embodiments may be implemented. Many modifications to the depicted environment may be made. The computing node 800 may be implemented as at least part of the file server 160 of FIG. 1A, file server 202 of FIG. 2, analytics system 216 of FIG. 2, and/or any other computing device and/or system described herein. In some examples, the computing node 800 may be a standalone computing node or part of a cluster of computing nodes configured to host a distributed file server (e.g., any of the file server virtual machines described herein).

The computing node 800 includes a communications fabric 802, which provides communications between one or more processor(s) 804, memory 806, local storage 808, communications unit 810, and I/O interface(s) 812. The communications fabric 802 can be implemented with any architecture designed for passing data and/or control information between processors (such as microprocessors, communications and network processors, etc.), system memory, peripheral devices, and any other hardware components within a system. For example, the communications fabric 802 can be implemented with one or more buses.

The memory 806 and the local storage 808 are computer-readable storage media. In this embodiment, the memory 806 includes random access memory RAM 814 and cache 816. In general, the memory 806 can include any suitable volatile or non-volatile computer-readable storage media. In an embodiment, the local storage 808 includes an SSD 822 and an HDD 824.

Various computer instructions, programs, files, images, etc. may be stored in local storage 808 for execution by one or more of the respective processor(s) 804 via one or more memories of memory 806. In some examples, local storage 808 includes a magnetic HDD 824. Alternatively, or in addition to a magnetic hard disk drive, local storage 808 can include the SSD 822, a semiconductor storage device, a read-only memory (ROM), an erasable programmable read-only memory (EPROM), a flash memory, or any other computer-readable storage media that is capable of storing program instructions or digital information.

The media used by local storage 808 may also be removable. For example, a removable hard drive may be used for local storage 808. Other examples include optical and magnetic disks, thumb drives, and smart cards that are inserted into a drive for transfer onto another computer-readable storage medium that is also part of local storage 808. The local storage may be configured to store executable instructions for an analytics system 807 and/or executable instructions for an audit framework 809. The analytics system 807 may perform operations described with reference to the analytics system 216 in some examples. In some examples, the memory 806 may be encoded with executable instructions for a query engine as described herein, such as query engine 244. In some examples, the computing node 800 may host one or more virtual machines and/or containers described herein. The audit framework 809 may perform operations described with reference to the audit framework of the file server 202 of FIG. 2 in some examples.

Communications unit 810, in these examples, provides for communications with other data processing systems or devices. In these examples, communications unit 810 includes one or more network interface cards. Communications unit 810 may provide communications through the use of either or both physical and wireless communications links.

I/O interface(s) 812 allows for input and output of data with other devices that may be connected to computing node 800. For example, I/O interface(s) 812 may provide a connection to external device(s) 818 such as a keyboard, a keypad, a touch screen, and/or some other suitable input device. External device(s) 818 can also include portable computer-readable storage media such as, for example, thumb drives, portable optical or magnetic disks, and memory cards. Software and data used to practice embodiments of the present disclosure can be stored on such portable computer-readable storage media and can be loaded onto local storage 808 via I/O interface(s) 812. I/O interface(s) 812 also connect to a display 820.

Display 820 provides a mechanism to display data to a user and may be, for example, a computer monitor. In some examples, a GUI associated with the user interface 238 of FIG. 2 and/or user interface 702 of FIG. 7 may be presented on the display 820.

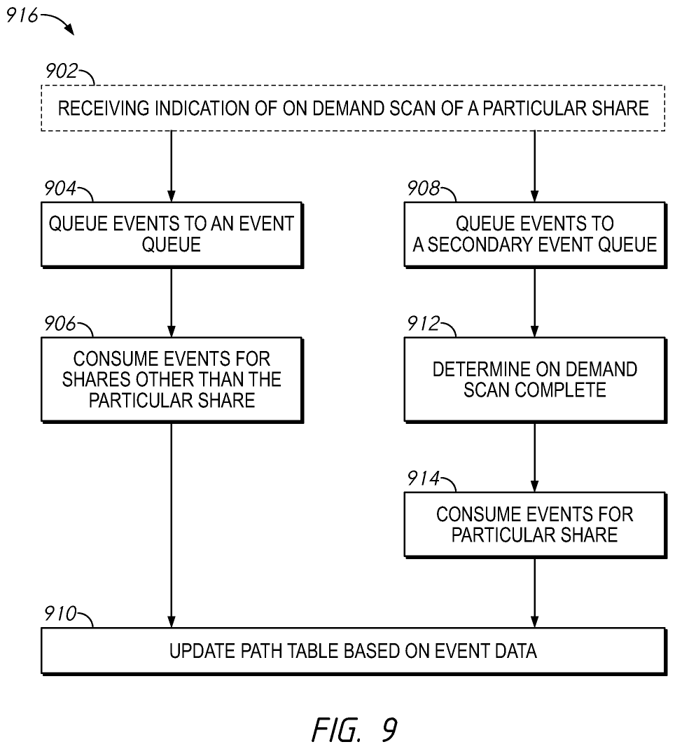

FIG. 9 is a schematic illustration of a method for updating paths in accordance with examples described herein when an on demand scan of a share is conducted. The method 916 includes block 902 “receiving indication of on demand scan of a particular share.” Block 902 may be followed by block 904 “queue events to an event queue.” Block 904 may be followed by block 906, “consume events for shares other than the particular share.” Block 906 may be followed by block 910, “update path table based on event data.” Block 902 may also be followed by block 908 “queue events to a secondary event queue.” Block 908 may be followed by block 912 “determine on demand scan complete.” Block 912 may be followed by block 914 “consume events for particular share.” Block 914 may be followed by block 910, “update path table based on event data.” The blocks shown in FIG. 9 are exemplary only. Additional, fewer, and/or different blocks may be used in other examples.

Examples of analytics systems described herein may be used to implement the method of FIG. 9. For example, the analytics system 216 of FIG. 2 may perform method 916. The query engine 244 may include software for performing the actions described with respect to method 916, for example. Other components of the analytics system 216 may perform all or portions of method 916 in other examples.

Examples of methods described herein may include receiving an indication of an on demand scan of a particular share. For example, the analytics system 216 of FIG. 2 may receive a request, through user interface 238, to conduct an on demand scan for a particular share. This request through the user interface 238 may provide an indication to query engine 244 that an on demand scan will occur. In some examples, the analytics system 216 may receive an indication of an on demand scan when it receives metadata for the particular share at the gateway 222 and/or event processor 224. Responsive to the on demand scan of a particular share of the file server 202, metadata for that particular share will be provided to the analytics system 216 and used to replace and/or update the datastore 226.

Responsive to the indication of an on demand scan, analytics systems described herein may queue event data into multiple queues for processing. For example, in block 904 of FIG. 9, events may be queued to an event queue. In block 908, event data may also be queued to a secondary event queue. Event data relating to changes taking place on the file server 202 may be provided to analytics system 216, such as to event processor 224. This data may be queued, e.g., by query engine 244, for processing for updates to path data (e.g., one or more path tables) in the datastore 226. Responsive to an indication of an on demand scan, the query engine 244 or other component may queue event data to multiple queues, e.g., in block 904 and block 908.

The query engine 244 or other component of analytics system 216 may execute a process to consume the events in the queue and make any indicated changes in the path data in view of the events. Note that the events received by the analytics system 216 may be events for multiple (e.g., all) shares of the file server 202. Accordingly, while an on demand scan is occurring, it may be desirable to continue to consume events relating to other shares which are not being scanned. Otherwise, the analytics presented by analytics system 216 may be out of date for the other shares, which may not be necessary.

Accordingly, examples of analytics systems described herein may consume events for shares other than a particular share subject to an on demand scan while the on demand scan is occurring. In FIG. 9, in block 906, a process may consume events from a queue. The events consumed may be only those which pertain to shares other than a particular share that is undergoing a metadata scan. The queued event data for the particular share may be deleted and/or disregarded by the process which is implementing block 906 in some examples.

In block 910, the process may update path data in the datastore 226 in accordance with path updating techniques described herein. Note that the process executing in block 906 will update the path table in block 910 using event data pertaining to shares other than the particular share undergoing an on demand scan. In this manner, other shares' path data may remain adjusted in accordance with event data, while event data may not be processed for a particular share undergoing an on demand scan.

Once an on demand scan is completed, analytics systems described herein may consume (e.g., process) the event data which arrived during the time the scan was occurring. In block 912, for example, the analytics system 216 may determine the on demand scan is complete. For example, the query engine 244 and/or other component of analytics system 216 may access scan status data to determine the on demand scan for the particular share is complete.

Responsive to determining the on demand scan is complete, event data for the particular share which arrived during the scan may be processed. In block 914, another process executed by the query engine 244 or another component of the analytics system 216 may consume events for the particular share which are stored in the secondary event queue. Events for shares other than the particular share may be deleted and/or disregarded in the secondary event queue. The event data for the particular share may be used by the process to update path data. For example, a path table may be updated in block 910 based on the data for the particular share.

In this manner, event data for a particular share may be stored but not processed during a time an on demand scan of the particular share is occurring. When the on demand scan is complete, the stored event data may be used to update path data in the analytics system.

From the foregoing it will be appreciated that, although specific embodiments have been described herein for purposes of illustration, various modifications may be made while remaining with the scope of the claimed technology. As an example, while file servers have been used as an example of sources of metadata and/or event data described herein, other architectures may be used in communication with analytics systems described herein. Generally, object stores may be in communication with one or more analytics systems described herein, and the analytics systems may receive metadata and/or event data from the object stores. Path tables maintained by the analytics systems may include key values of the object stores, for example.

Examples described herein may refer to various components as “coupled” or signals as being “provided to” or “received from” certain components. It is to be understood that in some examples the components are directly coupled one to another, while in other examples the components are coupled with intervening components disposed between them. Similarly, signals or communications may be provided directly to and/or received directly from the recited components without intervening components, but also may be provided to and/or received from the certain components through intervening components.

What is claimed is:

1. At least one non-transitory computer readable medium encoded with instructions which, when executed, cause a system to:
store metadata received from a file system in a datastore, the metadata including an object ID for each of a plurality of objects in the file system and a parent object ID for each of the plurality of objects in the file system;
query the datastore for a first path level, wherein the first path level corresponds to a first level object of the plurality of objects where the parent object ID is equal to the object ID;
construct a first level path for the first path level equal to a name for the first level object;
query the datastore for a next path level, wherein the next path level corresponds to a next level object of the plurality of objects where the parent object ID is equal to an object ID of the first level object; and
construct a next level path for the next path level, wherein the next level path includes a name for the next level object appended to the first level path.

2. The non-transitory computer readable medium of claim 1, wherein the instructions, when executed, further cause the system to:
store the first level path and the next level path in a path table.

3. The non-transitory computer readable medium of claim 2, wherein the instructions, when executed, further cause the system to:
update the path table based on event data received from the file system.

4. The non-transitory computer readable medium of claim 1, wherein the instructions, when executed, further cause the system to:
repeatedly query the datastore for increasing next path levels until no objects are returned.

5. The non-transitory computer readable medium of claim 1, wherein the metadata is received from a file system hosted by a distributed file server, the distributed file server having a plurality of file server virtual machines (FSVM), each configured to present a single namespace of files.

6. The non-transitory computer readable medium of claim 5, wherein the plurality of FSVMs are hosted by a plurality of computing nodes, and wherein the single namespace of files is stored in a storage pool including local storage of the plurality of computing nodes.

7. The non-transitory computer readable medium of claim 1, wherein the instructions, when executed, further cause the system to determine a metadata scan of the file system is complete prior to said query the data store for the first path level.

8. A method comprising:
receive metadata from a file system, wherein the metadata includes an object ID for each of a plurality of objects in the file system and a parent object ID for each of the plurality of objects in the file system;
generate a path table for the plurality of objects in the file system, wherein the path table comprises:
a complete path for each directory in the plurality of objects; and
a parent object ID for each file in the plurality of objects; and
wherein said generate the path table comprises constructing paths for top level objects of the plurality of objects, then constructing paths for each consecutive level of the file system.

9. The method of claim 8, further comprising:
updating the path table based on event data received from the file system.

10. The method of claim 9, wherein said updating comprises, responsive to an indication of a moved directory in the file system:
querying the path table for a prefix equal to an initial path of the moved directory; and
replacing the prefix in the path table with a new path of the moved directory.

11. The method of claim 8, wherein the file system is hosted by a distributed file server, and wherein the distributed file server includes a plurality of file server virtual machines (FSVMs) hosted on a respective plurality of computing nodes, wherein each of the FSVMs is configured to present a single name space of storage items.

12. The method of claim 11, wherein the storage items are stored in a storage pool, and wherein the storage pool includes local storage of the plurality of computing nodes.

13. The method of claim 8, further comprising:
receiving user input requesting analytics about the file system; and
displaying the analytics about the file system, including a path for a file in the file system, wherein the path is retrieved from the path table.

14. The method of claim 8, wherein the metadata from the file system does not include a complete path for each object ID in the file system.

15. The method of claim 8, further comprising determining the metadata receiving process is complete prior to generating the path table.

16. A system comprising:
a gateway configured to receive, at a cloud-based analytics system, metadata associated with a file system, wherein the metadata includes an object ID for each of a plurality of objects in the file system and a parent object ID for each of the plurality of objects;
a datastore configured to store the metadata; and
at least one processor and non-transitory computer readable media encoded with instructions which, when executed, cause the at least one processor to:
generate a path table based on the metadata, the path table including a complete path for each folder of the plurality of objects and a parent object ID for each file in the plurality of objects; and
store the path table in the datastore.

17. The system of claim 16, wherein the instructions, when executed, further cause the at least one processor to:
update the path table responsive to event data received from the file system.

18. The system of claim 17, wherein the event data comprises an indication a particular directory in the file system has moved, and wherein said update the path table comprises:
query the datastore for a prefix equal to a path of the particular directory prior to a move; and
replace the prefix with a path of the particular directory after the move.

19. The system of claim 17, wherein the file system is hosted by a distributed file server, wherein the distributed file server comprises a plurality of file server virtual machines (FSVMs) hosted by a plurality of computing nodes.

20. The system of claim 19, wherein the FSVMs are each configured to present a single namespace of storage items stored in a storage pool.

21. The system of claim 20, wherein the storage pool includes local storage of each of the plurality of computing nodes.

22. The system of claim 18, wherein the datastore comprises a data warehouse, and wherein the path table is not indexed.

23. A method comprising:
receiving an indication of a metadata scan of a particular share of a file server;
responsive to the indication of the metadata scan, queuing event data received during the scan to a first queue and a secondary queue;
processing event data for a share other then the particular share from the first queue at least in part during a time the metadata scan is occurring; and
after the metadata scan of the particular share is complete, processing event data for the particular share from the secondary queue.

24. The method of claim 23, wherein processing event data for the share other than the particular share comprises updating a path table for the share other than the particular share.

25. The method of claim 23, wherein processing event data for the particular share comprises updating a path table for the particular share.

26. The method of claim 23, wherein the processing event data comprises updating the path table responsive to an indication of a moved directory.

27. The method of claim 23, further comprising receiving metadata for the particular share responsive to the metadata scan and constructing paths for the particular share based on the metadata.
